(19) United States
(12) Patent Application Publication
(10) Pub. No.: US 2020/0169801 A1
(43) Pub. Date: May 28, 2020

(54) SAFE EARPHONE

(71) Applicant: AIDAO ZHU, WENZHOU, ZHEJIANG (CN)

(72) Inventor: AIDAO ZHU, WENZHOU, ZHEJIANG (CN)

(21) Appl. No.: 16/616,457

(22) PCT Filed: May 23, 2018
(86) PCT No.: PCT/CN2018/087957

§ 371 Date: Nov. 23, 2019

(30) Foreign Application Priority Data
May 23, 2017 (CN) 201710417231.6

(51) Int. Cl. H04R 1/10; H04R 3/00; H04R 1/08

(52) U.S. Cl. CPC H04R 1/1016; H04R 1/105; H04R 1/1075; H04R 2201/10; H04R 1/08; H04R 1/1083; H04R 3/00

(57) ABSTRACT

A safe earphone includes a wired safe earphone and an over ear safe headphone, having plurality of speakers with different frequency responses respectively used for two ears to listen, so the frequency response is particularly good; it is provided with a noise reduction signal conversion system which effectively converts the transmission of the active noise reduction frequency signal into the transmission of the passive audio signal and then restore to the transmission of the active audio signal after transmission of 1000 mm in length, therefore human body is isolated from radiation of communication at a long distance, which achieves a good a high degree of radiation protection, and solving the technical problem that the microphone of the existing radiation-proof earphone must be placed outside the air tube. Therefore, the invention is an excellent safe earphone achieving highly radiation-proof, having high sound quality and noise reduction function.

### FIELD OF THE INVENTION

The present invention relates to a radiation-proof or safe earphone device, and specifically to an anti-radiation earphone device and a stereo radiation-proof which are used for communication devices with high frequency magnetic field and intense radiation, such as a mobile phone. And more particularly, the invention relates to an earphone device which effectively improves the frequency response and is capable of generating a better stereo sound effect and has a better frequency response than traditional wired earphones.

### BACKGROUND OF THE INVENTION

An ordinary earphone, such as the one along with in a mobile phone or other communication devices, includes a plug, a conductive wire and earphone head, with the earphone having micro-loudspeakers installed therein. Since people directly use the phone to listen and talk, the super high frequency magnetic field or other harmful radiation caused by the mobile phone will severely stimulate brain nerves of people, hurting people's health. Usually, people use earphone device to answer a call in order to reduce the harm caused by many kinds of radiation rays such as super high frequency magnetic field, and electric wave and thermal energy. However, using the common earphone with a speaker directly mounted in the earphone heads is still unable to avoid the danger from transmitting the radiation rays such as the super high-frequency magnetic field to the ears and up into the brain. In addition, such earphone heads with loudspeakers mounted therein have the permanent magnetic field up to 1600 G, which also have drastic harm to people's brain. So, using frequently such mobile phone or the earphones for a long time can easily cause symptoms of headache, dizziness, numbness, etc.

An existing radiation-proof earphone for instance, a product called as “radiation-free earphone” with patent number ZL02244828.4 can reduce electromagnetic radiation, however, its sound wave channel is only 5-10 cm and does not have metal shielded wire, which can not reach the requirement of 2 mG or less. The purpose of being controlled as 2 mG or less is provided according to the theory of the inventor of the cell phone, Professor Shi Min of Taiwan Communication University, PhD of Stanford University in US, academician of American Academy of Engineering due to the harm to human by magnetic field. So the existing earphone cannot meet the requirement of anti-electromagnetic radiation as mentioned above. Meanwhile it has no sound cavity, thus frequency response is not good. The application No. 200810167226.5, entitled “Safe Earphone Device”, applied by the present inventor, discloses five inventions of a safe earphone device and methods of achieving radiation-free and improving the sound quality which is granted patents from nine countries. But sound quality of the safe earphone this patent is not better than the ordinary earphones. The application is to disclose a earphone of which the sound quality is better than the ordinary earphones as well as improve radiation-proof effect, which achieve no radiation.

Therefore, people extraordinarily need an earphone device which can prevent electromagnetic radiation and have a better frequency response, and have a better stereo effect.

### SUMMARY OF THE INVENTION

### Technical Problem

The present invention relates to a safe earphone which mainly includes a wired safe earphone and an over safe headphone, having plurality of speakers with different frequency responses respectively used for two ears to listen, so the frequency response is particularly good and better than the ordinary earphones; and setting up a noise reduction special solution, more importantly, it is provided with a noise reduction signal conversion system which effectively converts the transmission of the active noise reduction frequency signal into the transmission of the passive audio signal and then restore to the transmission of the active audio signal, which can make the passive audio transmission of the air tube be 1000 mm in length. Human body is isolated from radiation of communication at a long distance because of setting a metal shielded wire while a microphone is still kept at a close distance, which achieves a good noise reduction effect and a high degree of radiation protection as well as high sound quality and solving the technical problem that the microphone of the existing radiation-proof earphone must be placed outside the air tube. Because if the microphone is put too far away, the function of the microphone will be affected and its sound volume will be low.

The present invention is a good safe earphone devices with highly anti-radiation ability and highly anti-noise sound quality.

A safe earphone,

Includes an earphone head (1), provided therein with a sound cavity (2) which has a first end having a sound outlet,

A main body (4), provided therein with a sound collecting cavity (10) with a channel opening the channel opening is connected to a second end of the sound cavity (2) through a sound wave transmission channel (3).

a micro-loudspeaker (5), the sound collecting cavity (10) is between the micro-loudspeaker (5) and the sound wave transmission channel (3),

the micro-loudspeaker is connected with a first end of a conductor (8) outside the main body (4) and a second end of the conductor (8) is connected with a plug (9).

A microphone is set as a conversion system converting an active audio signal into a passive transmission signal and restoring to the active audio signal again.

The safe earphone as mentioned above,

the main body is provided therein with the sound collecting cavity, having two ends hermetically connected to one sound emitting end of the micro-speaker (5) and one end of a sound wave channel slot, so that transmitting a sound wave of the micro-loudspeaker (5) through the sound collecting cavity (10) to the sound cavity (2) by the sound wave transmission channel (3), the sound cavity (2) is provided with a sound outlet and a sleeves for the sound outlet on its top cover.

The safe earphone as mentioned above,

the main body (4) is provided therein with a microphone (6), the main body (4) has a sound receiver hole (13) corresponding to the microphone (6);

The main body (4) is provided with a switch 12. Both of the micro-loudspeaker (5) and the microphone (6) are connected to the switch 12, and are connected to the conductor 8 after then.

The safe earphone as mentioned above,

The sound wave transmission channel (3) is a tube made of insulating material, the inner diameter of the sound wave transmission 3 is between 1 mm and 6 mm, the length is between 20 mm and 800 mm;

The volume of the sound cavity (2) is 600 mm³-9000 mm³

The sound outlet is a hole with the diameter Φ of between 1 mm and 8 mm or with several holes with each hole having the diameter Φ of between 0.3 mm and 3 mm.

The safe earphone as mentioned above, the sound wave transmission channel (3) is 20 mm-1000 mm in length.

The safe earphone as mentioned above,

The sound collecting cavity (10) is of the inversed taper shape,

The safe earphone as mentioned above,

The bevel/arc/curve edge of the two pairs at the periphery of the sound collecting cavity is of inversed taper shaper. And the angle between bevel/arc/curve edges of each pair is between 9° and 130°.

The safe earphone as mentioned above,

There is at least one pair between the bevel/arc/curve edge of the two pairs at the periphery of the sound collecting cavity 10 is symmetrical.

The safe earphone as mentioned above,

Both of two pairs of the bevel/arc/curve edge at the periphery of the sound collecting cavity 10 is asymmetric.

The safe earphone as mentioned above,

The inversed taper shape refers to: the periphery of the sound collecting cavity 10 is of inversed taper shape with the peripheral formed by bevel lines; or the periphery of the sound collecting cavity 10 is of the inversed taper shape with the peripheral formed by arc lines; or the periphery of the sound collecting cavity 10 is of the inversed taper shape with the peripheral formed by curve lines; or the periphery of the sound collecting cavity 10 is of the inversed taper shape with the peripheral formed by arc (or curve) lines and bevel lines together.

The safe earphone as mentioned above,

The cross section of the cone of the sound collection cavity 10 or the cross section parallel to the bottom of the cone is oval shape, round shape, rectangle shape or polygon shape with adjacent sides formed by arc lines.

The safe earphone as mentioned above,

The microphone (6) is mounted in a circle hole on the main body (4), its sound receiving surface facing outward and sealed on the periphery, so that transmitting the sound through the sound receiving holes on the main body (4) to the microphone (6) by the sound receiving small holes in front of the sound receiving surface of the microphone.

The safe earphone as mentioned above,

The sound wave transmission channel (3) has one end fixed in the earphone head's inlet and the other end fixed at the small end of the sound collecting cavity's, and at the two ends of the sound wave transmission channel (3) is bulged by a hollow rivet (17-1), such that the sound wave transmission channel is fastened at the earphone head's inlet and the small end of the sound collecting cavity having the micro-loudspeaker mounted at the big end, the joint of three of them is sealed.

The safe earphone as mentioned above,

The sound wave transmission channel (3) has one end inserted over an earphone head's inlet while the other end over a sound collecting cavity's outlet; and both ends of the sound wave transmission channel (3) are sheathed with a jacket (17-2) outside, for tightening.

The safe earphone as mentioned above,

The conductor (8) uses metal shield line to make the conductor be grounded.

The safe earphone as mentioned above,

The number of the micro-loudspeaker (5) is 1, the number of the sound collecting cavity (10) is 1, and the number of the channel openings is 1, the sound from the micro-loudspeakers (5) is transmitted into one of earphone heads (1) via one of sound wave transmission channels (3) connected with one of the channel openings.

The safe earphone as mentioned above,

The number of the micro-loudspeakers (5) is 2, the number of the sound collecting cavities (10) is 2, one micro-loudspeaker corresponds to the big end of one sound collecting cavity (10) and the small end of each sound collecting cavity is provided with one channel opening, and one channel opening corresponds to one sound wave transmission channel and one earphone head.

The safe earphone as mentioned above,

The sound collecting cavity (10) has a structure with small top and big bottom.

The safe earphone as mentioned above,

The micro-loudspeakers (5) is of round shape or oval shape.

The safe earphone as mentioned above,

The micro-loudspeaker (5) is placed vertically or slantwise in the main body (4).

The safe earphone as mentioned above,

Is not provided with the main body, having a sound collecting cavity and a micro-loudspeaker together as a casing, provided with an additional small casing to mount therein the microphone, switch and volume control key.

The safe earphone as mentioned above,

The length of air tube is set as 20 mm or only use metal shield wire to prevent radiation

The safe earphone as mentioned above,

1) a safe over ear air tube headphone, having two sound chambers connected to the air tube (86) (92) of any length between 20 mm and 1000 mm, a audio cable uses the layer of an externally transparent or opaque metal shielded wire to make it grounded, one end of the audio cable is connected to the plug (98), and the other end is connected to a loudspeaker (88), the one end of the audio cable of a receiver (96) is also connected to the plug (98) and the other end is connected to the receiver (96) kept at a distance of 20 mm-100 mm from the loudspeaker (88) (94), the microphone (96) is provided with a housing (96-1),

Provided with one loudspeaker housing on left and right sides, or provided with two loudspeaker housings (89) (95) with two loudspeaker cavities (89) (95), having two loudspeakers (88) (94) mounted separately, the sound outlet of each loudspeaker is matched to the big end of the sound collecting cavity (87) (93) which are of inverse taper shaper, the small end is connected to the one end of the air tube (86) (92) and the other end of the air tube (86) (92) is hermetically connected to the sound cavity producing sound (85) (91), the sound cavity (85) (91) are mounted at the both ends of a head bow for listening, the joint of the sound outlet of each loudspeaker and its matching sound collecting cavity and the air tube are sealed.

2) The loudspeaker of the over ear headphone above mentioned in item 1 are all single-type loudspeaker, the present item is set up with two types of loudspeakers for one ear listening, that is both of two loudspeaker housings of the said headphone separately mount therein one more loudspeaker (106) (112), the frequency response of the added loudspeaker (106) (112) is different from that of the original loudspeaker (102) (113), that is mounting each one high-frequency and low-audio loudspeaker in both of the two loudspeaker housings, adding one more sound wave transmission channel in parallel, both of two receivers (99) (107) are provided with one more sound cavity as the receiver (107) of double sound cavities (117) (118) and the receiver (99) of double sound cavities (117-1) (118-1).

3) Based on the structure mentioned above, the over ear headphone without air tube removes the air tube, directly mounts the loudspeaker (120) (120-1) in the sound cavity (119) (119-1), the one end of the audio cable is connected to the loudspeakers (120) (120-1) when the other end is connected to the plug (124), the one end of the conductor of the receiver (121) is also connected to the plug (124) and the other end is connected to the end point of the receiver (121) by a adjustable supporting hose (124) or a metal wire, the adopted cable is made of an externally transparent or opaque metal shielded wire of which the layer making the cable grounded by setting one or several separately grounded or multiple combined grounded. Or install two loudspeakers with different frequency response in the sound cavity, so the frequency response is very wide and the sound quality will be very good!

The safe earphone as mentioned above,

1) Setting the air tube (127) of a wired earphone in any of length between 20 mm and 1000 mm and connecting its one end to a small hole (128) in the intersection of the small end of the two sound collecting cavities (129) (132), and installing one moving coil loudspeaker (130) and one moving iron loudspeaker (133), or install one loudspeaker with different frequency response at the big end of the sound collecting cavities (129) (132), the other end of the air tube (127) is connected to the sound cavity (125);

Or having two loudspeakers (143) (144) each mounted to the sound collecting cavity (142) (140), and transmitting the sound from the small end of the corresponding sound collecting cavity (142) (140) to the big end of the second stage sound collecting cavity (139), the small end of the second stage sound cavity (139) is connected to the one end of the air tube (138), the other end of the air tube (138) is connected to the sound cavity (136) of the corresponding earplug (137) for listening;

Or a mono earphone is provided with one moving iron loudspeaker (156) and one moving coil loudspeaker (153) or one loudspeaker with different frequency response for each, each of which is disposed to the big end of the sound collecting cavity (155) (152), the corresponding sound collecting cavity (155) (152) is separately disposed to one end of one of the air tube (151) (150), the other parallel end of the air tube (151) (150) is connected to the each corresponding sound cavity (147) (148) of the earplug (149) for listening;

Or opening two air tubes (151-1) (150-1) in a flat insulating hose (151-3), transmitting the sound waves of two kinds of loudspeaker (153) to the sound cavity of the earplug (149) for listening; or setting two sound cavities (147) (148) for the earplug (149), having two air tubes (151) (150) connected to the one end of one sound cavity (147) (148) and the other end of two sound cavities (147) (148) putted into ears for listening;

The connection of the above mentioned loudspeaker and sound collecting cavity, the connection of the sound collecting cavity and the second stage sound collecting cavity, the connection of the sound collecting cavity and air tube, the connection of air tube and earplug are all set to be sealed, isolating the magnetic field of the moving loudspeaker and the coil loudspeaker is via a metal or keeping the loudspeakers at a distance.

The setting above mentioned is a structure with the loudspeaker and the air tube and the earplug just for one ear listening, it needs to set two groups of the structure from the loudspeaker to the sound cavity of the earplug when provided for two ears listening, that is two earphones are separately provided with the moving iron loudspeaker (166) (167) and the moving coil loudspeaker (169) (178), correspondingly disposed at the big end of the sound collecting cavity (165) (175) and (168) (177). The corresponding sound collecting cavity (165) (175) and (168) (177 are separately disposed to one end of one of the air tube (163X 164) and (173) (174), and the other parallel end of the air tube (163)(164) and (173) (174) is connected to the each corresponding sound cavity (160)(161) of the earplug (162) and sound cavity (170)(171) of the earplug (172) for listening (As FIG. 28), to become a stereo wired earphone with dual frequency, so not only the sound quality is good but also the stereo sound is very strong.

The safe earphone as mentioned above,

The noise reduction safe over ear headphone is provided with a left ear cup (195), a sound chamber casing (195-3), a left ear casing (195-1), a right ear cup (194), a right ear casing (195-2), a headband (185), a switch and its switch housing (191), a noise reduction transmission arm (198), and a noise reduction converter (196), a housing (195-1), a speaker housing (190), a plug (193), provided with a noise reduction conversion system: converting the transmission from the active audio signal into the passive audio signal, setting the first microphone (32-1) wired to the circuit of a audio amplifier (As FIG. 32) to push the speaker (32-2), the circuit is decided by the length and diameter of the selected air tube, the big end of the sound collecting cavity is connected to the sound outlets of the speaker (32-2) and the small end is riveted to the one end of microphone air tubes (188-1) (187-1) of which the other end is connected to the small end of the sound cavity (203) of taper shape, the big end of the sound cavity (203) is connected to the a sound receiving face of a second microphone (204), the connection from the sound outlets of the speaker through the air tube to the sound receiving face of the second microphone is sealed; the other end of the second microphone is wired to the one end of a metal shielded wire (192) of which and the other end is connected to the one end of the plug (193), the other end of which is connected to the socket of communication device;

The active part of the conversion system is provided with an electronic circuit board (as FIG. 32), a battery to supply power circuit and its elements, a charging circuit and a charging socket connected to the battery, a power LED and a power switch, the active signal elements of the aforesaid conversion system are all mounted in the converter, the speaker of the conversion system is mounted in the middle of the first microphone, or the outboard of the sound cavity inside the left ear housing, (as FIG. 32). The circuit can change the amplification power of the circuit according to the length of the microphone air tube to select different chips and different circuits.

The signal transmission of the microphone is converted from active transmission into passive transmission then restore to active transmission again, which allows setting the air tube very long, and the microphone keeps at a very close distance to the sound outlet to achieve noise reduction, and meanwhile super-highly protect the ear and brain from the harm of communication devices.

As FIG. 33, the one end of the left ear air tube (187-1) is connected to the inlet of the sound cavity producing the sound (209-1), meanwhile the other end is connected to the small end of the sound collecting cavity (205) of which the big end of the sound collecting cavity is connected to the speaker (207), the other end of which is wired to the metal shielded wire (192); the one end of the right ear air tube (188-1) is connected to the entry of the right sound cavity producing the sound when the other end of the right air tube passes through the left ear casing (195-1) along the outboard of the metal headband (186), with the left ear air tube (187-1) parallel to the speaker casing (190) and is connected to the small end of the right ear sound collecting cavity (206), the other end of which is connected to the one end of a right ear speaker (208), the other end of the right ear speaker (208) is wired to the one end of metal shielded wire (192) through the switch (191), the other end of the metal shielded wire (192) is connected to the plug (193), or mounting both of the left and right ear speakers, the left and right ear sound collecting cavities and the second microphone in the switch casing in the same connection way, the outlet of the sound cavity producing the sound is provide with one small hole or several holes, the convection hole of the aforesaid speaker exhaust airflow to the outside of its casing, the microphone is isolated from the speaker;

The three air tubes are parallelly bonded sides by sides (FIG. 33-1), or all bonded together and its cross-section is a triangle shape (FIG. 33-4), or all bonded together covered by flexible material outside and its cross-section is of triangle shape;

Or setting the right air tube obliquely pulled from the speaker casing to the inlet of the right ear sound cavity, that is not passing along a metal headband.

Or aforesaid three air tubes are pulled out of the E side of the switch casing and are connected to the inside of the left ear casing;

The noise reduction safe over ear headphone used as a mono circuit merges the left and right ear speakers into one speaker connected to one sound wave transmission tube by one sound collecting cavity, connects the sound wave transmission tube to the inlet of a tee of the left ear sound cavity, aforesaid tee has two outlets with one outlets connected to the inlet of the left ear sound cavity and the other connected to the left ear sound cavity by one sound wave transmission tube along the headband.

Each seam of the casings must be glued and waterproof when assembled.

Noise reduction safe over ear mono headphone

The noise reduction safe over ear mono headphone is provided with a flexible bow clip (199) mounted on a casing (200-1), a clamping piece 201 of round or other shapes mounted at the end point of the bow clip.

The one end of the microphone air tube (206) is connected to the small end of the sound collecting cavity of the converter, the big end of the sound collecting cavity is connected to the sound outlet face of the speaker of the converter, the other end of which is connected to the small end of a taper-shaped sound cavity (203-1), the big end of which is connected to the sound receiving face of the second microphone (204-1), the other end of the second microphone (204-1) is wired to the one end of the metal shielded wire (205) of which the other end is connected to the plug (206);

the one end of the left ear air tube (200-1) is connected to the inlet of the sound cavity producing the sound (structure as FIG. 33-2, sound cavity No.: 209-2) inside the casing (200-1), meanwhile the other end is connected to the small end of the sound collecting cavity (205-1), the big end of which is connected to the one end of the speaker (207-1) of which the other end is wired to the one end of the metal shielded wire (205), the other end of the metal shielded wire (205) is connected to the plug (206), the microphone, the left ear speaker and the sound collecting cavity uses a separator among them to isolate the sound.

The signal transmission of the microphone is converted from active transmission into passive transmission then restore to active transmission again, which allows setting the air tube very long, and the microphone keeps at a very close distance to the sound outlet to achieve noise reduction, and meanwhile super-highly protect the ear and brain from the harm of communication devices.

The safe earphone as mentioned above,

A noise reduction safe mono ear hook earphone is provided with a three-in-one bracket main body, the main body is provided with a ear hook (211), the front of which is a noise reduction transmission arm (198-2) having a conversion system (196-2) at its end, the main body is provided therein with a earplug with the sound cavity (structure as FIG. 33-2, sound cavity No. 209-3), the one end of the air tube (212) of the earplug is connected to the inlet of the sound cavity (209-3), meanwhile the other end of the air tube (212) is connected to the small end of the sound collecting cavity (212-1) having the speaker (214-1) mounted at the big end, both of the speaker (214-1) and the second microphone (214-2) are separately mounted in the speaker casing (214) to avoid the sound interference with each other;

The safe earphone as mentioned above,

A portable hand-held safe headset is provided with a hand arm (230) having a receiver sound cavity (218) with a top cover (228) at the top, the one end of the sound cavity (218) is connected to the one end of the air tube (220), meanwhile the other end of the air tube (220) is connected to the small end of the sound collecting cavity (222), the big end of the sound collecting cavity (222) is connected to the speaker (224), a connecting wire of the speaker (224) and the connecting wire of the microphone (223) are connected to the metal shielded wire (226) by the switch (231), the other end of the wire (226) is connected to the plug (225);

The switch (231) is set at the side of the middle of the portable hand-held safe headset, a button of the switch (231) operates the electric switch by the mechanical transmission of the link to disconnect or connect the speaker (224) and microphone (223); or having the top of the button of the switch pushing up a long arm (232) of a micro-switch (233) to disconnect or connect the micro-switch (233), so that the active circuit is always kept at a distance from human brains, the microphone and the speaker are mounted in two cavities of which the sound is isolated from each other under the main body, the wire of the microphone is sealed with glue after passing through the separator, so that the arrangement can achieve a good anti-radiation effect, the main body casing can be disassembled or assembled by upper and lower assembly, each seam of the casing should be glued and waterproof when assembled.

The noise reduction portable hand-held safe headset mentioned above can be used by plugging in the communication devices or directly being connected to the landline.

The underpart of the main body (230-1) of the noise reduction portable hand held safe headset is provided with a noise reduction microphone signal conversion system: converting the transmission from the active audio signal into passive audio signal, and sets the first microphone (239) wired to a second audio amplifying circuit to drive the speaker (238), the sound outlet of the speaker (238) is connected to the big end of the sound collecting cavity (236), the small end of which is riveted to the one end of a microphone air tube (240), the other end of the microphone air tube (240) is connected to the small end of the taper-shaped sound cavity (243) of which the big end is connected to the sound receiving face of the second microphone, the connection between the sound outlet of the microphone and the sound receiving face of the second microphone is sealed, the other end of the second microphone (243) is wired to the one end of the metal shielded wire (245) of which the other end is connected to the plug (246).

The active part of the conversion system is provided with a battery to supply the power circuit and its elements, a charging circuit connected with battery and a charging socket and its LED, the speaker (238) and the first microphone (239) are separately mounted in the two cavities of which the sound is isolated from each other inside the main body (230-1), the wire of the first microphone is sealed with glue after passing through the separator,

The second microphone (243) and the speaker (241) are disposed in the casing (230-2) and are separated by a sound baffle, the sound receiving face of the speaker (241) is connected to the big end of the sound collecting cavity (242), the small end of which is connected to the air tube of the speaker (241). The other end of the air tube of the speaker is connected to the one end of a sound cavity (281-1). The speaker (241) is wired to the one end of a metal shielded wire (245), the other end of which is connected to the plug (246).

The casing of the main body is disassembled by sealing upper and lower part, the joint surface and the other exposed seams should be sealed with glue and waterproof when assembled.

The noise reduction portable hand-held safe headset can be used by plugging in the communication devices or directly being connected to the landline.

A noise reduction aviation over-ear safe headphone is provided with the structure including a leather headband, a stitched steel head bow (247), the head bow (247) and an adjustable bracket (251) fixed together by screws, the adjustable bracket (251) and a fixing bracket (252) are fixed together by self-locking nuts, the fixing bracket (252) is connected to a left ear casing (253) through lock pillars. the right ear casing (250) is connected and fixed in the symmetric and same way as the left ear casing (253);

The first noise reduction microphone is mounted in the noise reduction converter casing (254) connected to a universal hose (255) with a variable gear, the left ear and right ear sound cavity is disposed in the ear casing, the air tube (258) of the right sound cavity passes through the left ear casing and is connected to the sound cavity inside the right ear casing along a steel bow (247), or is obliquely pulled from the speaker casing (256) to the right ear casing and then to the sound cavity therein, Or the left and right sound cavity are separately connected to an air tube (As FIG. 42, FIG. 43)

Separately provides with three speakers with different frequency response, three sound wave transmission channels with different response, sound chambers connected to the channels and wires of sound wave transmission channels for one ear or two ear, the two earphones are separately provided with the moving iron speaker (166) (176) and the moving coil speaker (169) (178), each of them is separately disposed in big end of the sound collecting cavity (165) (175) and (178) (177), the sound collecting cavity (165) (175) and (178) (177) is separately configured to the one end of the air tube (163) (164) and (173) (174) of which the parallel end is separately connected to the sound cavity (160) (161) inside the earplug (162) and the sound cavity (170) (171) inside the earplug (172), adding one more pair of speakers, air tubes and sound chambers while setting the speaker with three different frequency response.

Stereo model is the safe earphone with super high sound quality.

Set to separately provides with several speakers with different frequency response for one ear or two ears is the noise reduction safe earphone with high sound quality.

The two ends of the air tube 1A and the sound collecting cavity or the sound cavity 2A are all fixed with hollow 3A or glue or by other ways, the shape of the air tube 6A includes straight shape, partly spiral shape, all spiral shape, or the shape with middle spiral and two ends straight, or set the air tube to be a bend 4A which can be hooked to the ears, the end point of the bend 4A is provided with the earplug having a sound cavity.

Set part of wire to be straight or all of it to be spiral, or one section to be straight and one section to be spiral, or one section to be spiral and its two ends to be straight. Or set the air tube to be a bend 4A which can be hooked to the ears, and put the earplug 5A into the ear for listening after then.

Select the appropriate position in the side or the back of the sound cavity to open micro holes for air convection. The size of the small micro holes affects the sound volume.

The beneficial effect of the present invention

The power transmitted by the radio is much larger than that of the mobile phone, and people who work at radio station wear the headphone the whole day, so it is very necessary to prevent radiation. The noise reduction anti-radiation earphone of the present invention can set the air tube 1000 mm, or 3000-7000 mm in length or even much longer by converting the active signal into passive signal to achieve super highly radiation proof effect. As radiation is inversely proportional to the square of the distance in attenuation, which means the length of air tube is longer, the anti-radiation performance is increased proportional to the square of its length, and greatly improves the anti-radiation performance. So, the anti-radiation earphones are really needed in life.

Also, it can be used as an earphone for listening or speaking in the electromagnetic field scanning area of medical or other equipment, and the use of the earphone of the present invention in the electromagnetic field scanning area would not affect the scanning effect and quality, and thus achieves a good effect.

### BRIEF DESCRIPTION OF THE DRAWINGS

FIG. 1 is a right schematic view of the safe earphone according to the present invention, having two loudspeaker placed vertically and sound collecting cavity;

FIG. 2 is a main schematic view of the safe earphone according to the present invention, having two loudspeaker placed vertically and sound collecting cavity;

FIG. 3 is a right schematic view of the safe earphone according to the present invention, having one loudspeaker placed flatly or slantwise and symmetrical sound collecting cavity;

FIG. 4 is a main schematic view of the safe earphone according to the present invention, having one loudspeaker placed flatly or slantwise and symmetrical sound collecting cavity;

FIG. 5 is a schematic view of a small sealed box with one loudspeaker, one sound wave transmission channel and the symmetrical sound collecting cavity according to the present invention;

FIG. 6 is a rectangular A-A cross section view of the sound collecting cavity according to the present invention;

FIG. 7 is an oval A-A cross section view of the sound collecting cavity according to the present invention;

FIG. 8 is a circular A-A cross section view of the sound collecting cavity according to the present invention;

FIG. 9 is a schematic view of the installation of the microphone according to the present invention;

FIG. 10 is an enlarged view of the installation of the microphone according to the present invention;

FIG. 11 is a cross section view of the installation of the microphone according to the present invention;

FIG. 12 is a schematic view of the fixing method of the rivet;

FIG. 13 is a schematic view of the fixing method of the nut;

FIG. 14 is a main schematic view of the safe earphone according to the present invention, having a earplug, a micro loudspeaker and a microphone disposed altogether in a casing of which outboard is provided with a switch;

FIG. 15 is a main schematic view of the safe earphone according to the present invention, having both of a earplug and a micro loudspeaker disposed in a casing, both of a microphone and a switch disposed in a small casing of which the other end is connected to the metal shielded wire;

FIG. 16 is a main schematic view of the safe earphone according to the present invention, having two earplugs and two micro loudspeakers separately disposed in the casing, both of a microphone and a switch disposed in a small casing of which the other end is connected to the metal shielded wire;

FIG. 17 is a main schematic view of the safe earphone according to the present invention, having a earplug and a micro loudspeaker disposed in the sound cavity altogether, the microphone and the switch disposed in a small casing altogether;

FIG. 17 is a main schematic view of the safe earphone according to the present invention, having two earplugs and two micro loudspeakers disposed in two sound cavities altogether, a microphone and a switch disposed in the small casing altogether;

FIG. 19 is a schematic view of the over ear safe air tube stereo headphone;

FIG. 20 is a schematic view of the earphone additionally provided with the speaker 105,111 and the corresponding air tubes and sound cavities based on the structure as FIG. 19;

FIG. 21 is a cross section view of the sealed joint of the air tube of two sound cavities and the sound collecting cavities;

FIG. 22 is a cross section view of two sound cavities;

FIG. 23 is a side section view of the over ear radiation proof headphone adopting with the metal shielded wire to achieve radiation protection;

FIG. 24 is a schematic view of the over ear radiation proof headphone adopting with the metal shielded wire to achieve radiation protection;

FIG. 25 is a schematic view of the wired earphone, having two speakers with different frequency response connected to a sound chamber by an air tube for listening;

FIG. 26 is a schematic view of the wired earphone, having two speakers with different frequency response connected to a sound chamber with an air tube for one ear listening;

FIG. 27 is a schematic view of the wired earphone, having two speakers with different frequency response connected to two sound cavities by two air tubes for one ear listening;

FIG. 27-1 is a structure diagram of two air tubes passing through the casing;

FIG. 27-2 is a schematic view of a two-tube integrated air tube shaped of noodle;

FIG. 28 is a schematic view of the stereo wired earphone, having two groups of two speakers with different frequency response connected to two sound chambers by two air tubes for two ears listening;

FIG. 29 is a side section view of the noise reduction safe over ear headphone;

FIG. 30 is a front view of the noise reduction safe over ear headphone;

FIG. 31 is a top view of the noise reduction safe over ear headphone;

FIG. 32 is an circuit principle diagram of an audio converter that amplifies the audio signal of a microphone and convert it into a sound, and has a principle circuit of charging and power supply. The circuit can change the amplification power of the circuit according to the length of the microphone air tube to select different chips and different circuits;

FIG. 33 is a schematic view of structure of the noise reduction safe over ear headphone, having left and right ear sound wave channel, speakers, air tubes of microphone and the first microphone;

FIG. 33-1 is a schematic view of three air tubes parallelly bonded sides by sides;

FIG. 33-2 is a schematic view of the connection between the sound wave channel of the speaker and the sound cavity;

FIG. 33-3 is a schematic view of another kind of sound cavity;

FIG. 33-4 is a schematic view of three air tubes bonded together, having its cross-section shaped of triangle;

FIG. 34 is a side section view of the structure of the noise reduction mono over ear headphone;

FIG. 35 is a front view of the structure of the noise reduction mono over ear headphone;

FIG. 36 is a schematic view of the structure of the noise reduction safe mono ear hook earphone;

FIG. 37 is a full section view of the structure of the portable hand-held safe headset;

FIG. 38 is a schematic view of both of the appearance of the portable hand-held safe headset and the long pole switch;

FIG. 39 is a schematic view of the structure of both of the appearance of the portable hand-held safe headset and a switch;

FIG. 40 is a schematic view of the structure of the switch, having the micro-switch away from the switch button;

FIG. 41 is a schematic view of the permutation structure of the noise reduction portable hand-held safe headset;

FIG. 42 is a side section view of the structure of the noise reduction aviation over-ear safe headphone;

FIG. 43 is a front section view of the structure of the noise reduction aviation over-ear safe headphone;

FIG. 44 is a front section view of the structure of the air tube or the conductor curvedly hooked on ears;

FIG. 45 is a side section view of the structure of the earplug curvedly hooked on ears by the air tube or the conductor;

FIG. 46 is a schematic view of the air tube connected to the sound cavity by hollow rivets.

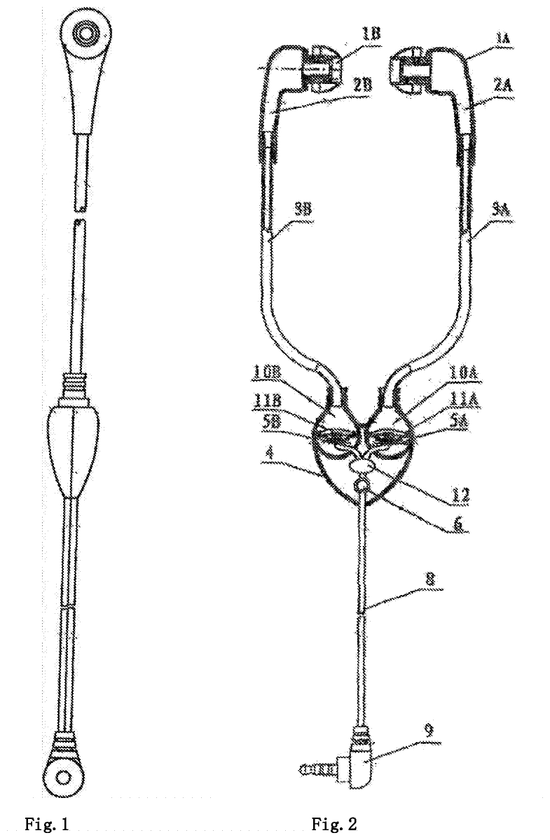

### DETAIL DESCRIPTION OF THE PREFERRED EMBODIMENTS

### Embodiment 1

A safe earphone,

includes an earphone head (1), provided therein with a sound cavity (2) which has a first end having a sound outlet;

A main body (4), provided therein with a sound collecting cavity (10) with a channel opening the channel opening is connected to a second end of the sound cavity (2) through a sound wave transmission channel (3);

A micro-loudspeaker (5), the sound collecting cavity (10) is between the micro-loudspeaker (5) and the sound wave transmission channel (3);

The micro-loudspeaker is connected with a first end of a conductor (8) outside the main body (4) and a second end of the conductor (8) is connected with a plug (9).

A microphone is set as a conversion system converting an active audio signal into a passive transmission signal and restoring to the active audio signal again.

### Embodiment 2

The safe earphone as mentioned above,

The main body is provided therein with the sound collecting cavity, having two ends hermetically connected to one sound emitting end of the micro-speaker (5) and one end of a sound wave channel slot, so that transmitting a sound wave of the micro-loudspeaker (5) through the sound collecting cavity (10) to the sound cavity (2) by the sound wave transmission channel (3), the sound cavity (2) is provided with a sound outlet and a sleeves for the sound outlet on its top cover.

### Embodiment 3

The safe earphone as mentioned above,

The main body (4) is provided therein with a microphone (6), the main body (4) has a sound receiver hole (13) corresponding to the microphone (6);

The main body (4) is provided with a switch (12). Both of the micro-loudspeaker (5) and the microphone (6) are connected to the switch (12), and are connected to the conductor 8 after then.

### Embodiment 4

The safe earphone as mentioned above,

The sound wave transmission channel (3) is a tube made of insulating material, the inner diameter of the sound wave transmission (3) is 3 mm, and the length is 300 mm;

The volume of the sound cavity is 1500 mm³

The sound outlet is a hole with the diameter Φ of 2 mm or with several holes with each hole having the diameter Φ of 2 mm

### Embodiment 5

The safe earphone as mentioned above,

The sound wave transmission channel (3) is 500 mm in length.

### Embodiment 6

The safe earphone as mentioned above,

The bevel edge of the two pairs at the periphery of the sound collecting cavity is of inversed taper shaper. And the angle between bevel edges of each pair is 60°.

### Embodiment 7

The safe earphone as mentioned above,

There is at least one pair between the curve edge of the two pairs at the periphery of the sound collecting cavity (10) is symmetrical.

### Embodiment 8

The safe earphone as mentioned above,

Both of two pairs of the arc edge at the periphery of the sound collecting cavity (10) is asymmetric.

### Embodiment 9

The safe earphone as mentioned above,

The inversed taper shape means that the periphery of the sound collecting cavity (10) is of inversed taper shape with the peripheral formed by bevel lines

### Embodiment 10

The safe earphone as mentioned above,

The periphery of the sound collecting cavity (10) is of the inversed taper shape with the peripheral formed by arc (or curve) lines and bevel lines together.

### Embodiment 11

The safe earphone as mentioned above,

The cross section of the cone of the sound collection cavity (10) is oval shape.

### Embodiment 12

The safe earphone as mentioned above,

The cross section parallel to the bottom of the cone of the sound collection cavity (10) is polygon shape with adjacent sides formed by arc lines.

### Embodiment 13

The safe earphone as mentioned above,

The microphone (6) is mounted in a circle hole on the main body (4), its sound receiving surface facing outward and sealed on the periphery, so that transmitting the sound through the sound receiving holes on the main body (4) to the microphone (6) by the sound receiving small holes in front of the sound receiving surface of the microphone.

### Embodiment 14

The safe earphone as mentioned above,

The sound wave transmission channel (3) has one end fixed in the earphone head's inlet and the other end fixed at the small end of the sound collecting cavity's, and at the two ends of the sound wave transmission channel (3) is bulged by a hollow rivet (17-1), such that the sound wave transmission channel is fastened at the earphone head's inlet and the small end of the sound collecting cavity having the micro-loudspeaker mounted at the big end, the joint of three of them is sealed.

### Embodiment 15

The safe earphone as mentioned above,

The sound wave transmission channel (3) has one end inserted over an earphone head's inlet while the other end over a sound collecting cavity's outlet; and both ends of the sound wave transmission channel (3) are sheathed with a jacket (17-2) outside, for tightening.

### Embodiment 16

The safe earphone as mentioned above,

The conductor (8) uses metal shield line to make the conductor be grounded.

### Embodiment 17

The safe earphone as mentioned above,

The number of the micro-loudspeaker (5) is 1, the number of the sound collecting cavity (10) is 1, and the number of the channel openings is 1, the sound from the micro-loudspeakers (5) is transmitted into one of earphone heads (1) via one of sound wave transmission channels (3) connected with one of the channel openings.

### Embodiment 18

The safe earphone as mentioned above,

The number of the micro-loudspeakers (5) is 2, the number of the sound collecting cavities (10) is 2, one micro-loudspeaker corresponds to the big end of one sound collecting cavity (10) and the small end of each sound collecting cavity is provided with one channel opening, and one channel opening corresponds to one sound wave transmission channel and one earphone head.

### Embodiment 19

The safe earphone as mentioned above,

The sound collecting cavity (10) has a structure with small top and big bottom.

### Embodiment 20

The safe earphone as mentioned above,

The micro-loudspeakers (5) is of round shape

### Embodiment 21

The safe earphone device as above

The micro-loudspeaker (5) is placed vertically in the main body (4).

### Embodiment 22

The safe earphone as mentioned above,

Is not provided with the main body, having a sound collecting cavity and a micro-loudspeaker together as a casing, provided with an additional small casing to mount therein the microphone, switch and volume control key.

### Embodiment 23

The safe earphone as mentioned above,

Only metal shielded wire is adopted to prevent radiation

### Embodiment 24

The safe earphone as mentioned above,

A safe over ear air tube headphone of the present embodiment, having two sound chambers connected to the air tube (86) (92) of which length is 600 mm, a audio cable uses the layer of an externally transparent or opaque metal shielded wire to make it grounded, one end of the audio cable is connected to the plug (98), and the other end is connected to a loudspeaker (88), the one end of the audio cable of a receiver (96) is also connected to the plug (98) and the other end is connected to the receiver (96) kept at a distance of 50 mm from the loudspeaker (88) (94), the microphone (96) is provided with a housing (96-1), or several microphones and loudspeakers are mounted in a housing to isolate the interference from each other, so that the volume is smaller because the structure is more simple.

### Embodiment 25

The safe earphone as mentioned above,

It is provided with two loudspeaker housings (89) (95) with two loudspeaker cavities (89) (95), having two loudspeakers (88) (94) mounted separately, the sound outlet of each loudspeaker is matched to the big end of the sound collecting cavity (87) (93) which are of inverse taper shaper, the small end is connected to the one end of the air tube (86) (92) and the other end of the air tube (86) (92) is hermetically connected to the sound cavity producing sound (85) (91), the sound cavity (85) (91) are mounted at the both ends of a head bow for listening, the joint of the sound outlet of each loudspeaker and its matching sound collecting cavity and the air tube are sealed, other settings are all the same as claim 24.

### Embodiment 26

The safe earphone as mentioned above,

The present example of the embodiment is set up with two types of loudspeakers for one ear listening, that is both of two loudspeaker housings of the headphone according to the claim 24 separately mount therein one more loudspeaker (106) (112), the frequency response of the added loudspeaker (106) (112) is different from that of the original loudspeaker (102) (113), that is mounting each one high-frequency and low-audio loudspeaker in both of the two loudspeaker housings, adding one more sound wave transmission channel in parallel, both of two receivers (99) (107) are provided with one more sound cavity as the receiver (107) of double sound cavities (117) (118) and the receiver (99) of double sound cavities (117-1) (118-1), the connection way of the added loudspeaker, the air tube and the sound chamber is the same as claim 24

### Embodiment 27

The safe earphone as mentioned above,

The over ear headphone without air tube in this embodiment removes the air tube based on the structure according to claim 1, directly mounts the loudspeaker (120) (120-1) in the sound cavity (119) (119-1), the one end of the audio cable is connected to the loudspeakers (120) (120-1) when the other end is connected to the plug (124), the one end of the conductor of the receiver (121) is also connected to the plug (124) and the other end is connected to the end point of the receiver (121) by a adjustable supporting hose (124) or a metal wire, the adopted cable is made of an externally transparent or opaque metal shielded wire of which the layer making the cable grounded by setting one or several separately grounded or multiple combined grounded. Or install two loudspeakers with different frequency response in the sound cavity, so the frequency response is very wide and the sound quality will be very good!

### Embodiment 28

The safe earphone as mentioned above,

Setting the air tube (127) of a wired earphone being 500 mm in length, and connecting its one end to a small hole (128) in the intersection of the small end of the two sound collecting cavities (129) (132), and installing one moving coil loudspeaker (130) and one moving iron loudspeaker (133), the other end of the air tube (127) is connected to the sound cavity (125).

The connection of the above mentioned loudspeaker and sound collecting cavity, the connection of the sound collecting cavity and the second stage sound collecting cavity, the connection of the sound collecting cavity and air tube, the connection of air tube and earplug are all set to be sealed, isolating the magnetic field of the moving loudspeaker and the coil loudspeaker is via a metal.

### Embodiment 29

The safe earphone as mentioned above,

Having two loudspeakers (143) (144) each mounted to the sound collecting cavity (142) (140), and transmitting the sound from the small end of the corresponding sound collecting cavity (142) (140) to the big end of the second stage sound collecting cavity (139), the small end of the second stage sound cavity (139) is connected to the one end of the air tube (138), the other end of the air tube (138) is connected to the sound cavity (136) of the corresponding earplug (137) for listening. Other structures keep the same as embodiment 28.

### Embodiment 30

The safe earphone as mentioned above,

A mono earphone in this embodiment is provided with one moving iron loudspeaker (156) and one moving coil loudspeaker (153), each of which is disposed to the big end of the sound collecting cavity (155) (152), the corresponding sound collecting cavity (155) (152) is separately disposed to one end of one of the air tube (151) (150), the other parallel end of the air tube (151) (150) is connected to the each corresponding sound cavity (147) (148) of the earplug (149) for listening. Other structures keep the same as embodiment 28.

### Embodiment 31

The safe earphone as mentioned above,

Opening two air tubes (151-1) (150-1) in a flat insulating hose (151-3), transmitting the sound waves of two kinds of loudspeaker (153) to the sound cavity of the earplug (149) for listening. Other structures keep the same as embodiment.

### Embodiment 32

The safe earphone as mentioned above,

Setting two sound cavities (147) (148) for the earplug (149), having two air tubes (151) (150) connected to the one end of one sound cavity (147) (148) and the other end of two sound cavities (147) (148) putted into ears for listening. Other structures keep the same as embodiment 28.

### Embodiment 33

The safe earphone as mentioned above,

The earphone in the present embodiment is for two ear listening, it needs to set two groups of the structure from the loudspeaker to the sound cavity of the earplug while provided for two ears listening, that is two earphones are separately provided with the moving iron loudspeaker (166) (167) and the moving coil loudspeaker (169) (178), correspondingly disposed at the big end of the sound collecting cavity (165) (175) and (168) (177). the corresponding sound collecting cavity (165) (175) and (168) (177 are separately disposed to one end of one of the air tube (163)(164) and (173) (174), and the other parallel end of the air tube (163X 164) and (173) (174) is connected to the each corresponding sound cavity (160)(161) of the earplug (162) and sound cavity (170)(171) of the earplug (172) for listening, become a stereo wired earphone with dual frequency, so not only the sound quality is good but also the stereo sound is very strong.

### Embodiment 33

The safe earphone as mentioned above,

The noise reduction safe over ear headphone in the present embodiment is provided with a left ear cup (195), a sound chamber casing (195-3), a left ear casing (195-1), a right ear cup (194), a right ear casing (195-2), a headband (185), a switch and its switch housing (191), a noise reduction transmission arm (198), and a noise reduction converter (196), a housing (195-1), a speaker housing (190), a plug (193), provided with a noise reduction conversion system: converts the transmission from the active audio signal into the passive audio signal, setting the first microphone (32-1) wired to the circuit of a audio amplifier (As FIG. 32) to push the speaker, the circuit is decided by the length and diameter of the selected air tube, the big end of the sound collecting cavity is connected to the sound outlets of the speaker (32-2) and the small end is riveted to the one end of microphone air tubes (188-1) (187-1) of which the other end is connected to the small end of the sound cavity (203) of taper shape, the big end of the sound cavity (203) is connected to the a sound receiving face of a second microphone (204), the connection from the sound outlets of the speaker through the air tube to the sound receiving face of the second microphone is sealed; the other end of the second microphone is wired to the one end of a metal shielded wire (192) of which and the other end is connected to the one end of the plug (193), the other end of which is connected to the socket of communication device.

The active part of the conversion system is provided with an electronic circuit board (as FIG. 32), a battery to supply power circuit and its elements, a charging circuit and a charging socket connected to the battery, a power LED and a power switch, the active signal elements of the aforesaid conversion system are all mounted in the converter, the speaker of the conversion system is mounted in the middle of the first microphone, or the outboard of the sound cavity inside the left ear housing, (as FIG. 32).

The signal transmission of the microphone is converted from active transmission 18i into passive transmission then restore to active transmission again, which allows setting the air tube very long, and the microphone keeps at a very close distance to the sound outlet to achieve noise reduction, and meanwhile super-highly protect the ear and brain from the harm of communication devices.

the one end of the left ear air tube (187-1) is connected to the inlet of the sound cavity producing the sound (209-1), meanwhile the other end is connected to the small end of the sound collecting cavity (205) of which the big end of the sound collecting cavity is connected to the speaker (207), the other end of which is wired to the metal shielded wire (192); the one end of the right ear air tube (188-1) is connected to the entry of the right sound cavity producing the sound when the other end of the right air tube passes through the left ear casing (195-1) along the outboard of the metal headband (186), with the left ear air tube (187-1) parallel to the speaker casing (190) and is connected to the small end of the right ear sound collecting cavity (206), the other end of which is connected to the one end of a right ear speaker (208), the other end of the right ear speaker (208) is wired to the one end of metal shielded wire (192) through the switch (191), the other end of the metal shielded wire (192) is connected to the plug (193).

The three air tube are parallelly bonded sides by sides, covered by flexible material outside.

### Embodiment 34

The safe earphone as mentioned above,

The left and right loudspeakers and the second microphone are mounted in the switch casing in this embodiment with the same connection ways embodiment 33. Three air tubes are bonded together covered by flexible material outside and its cross-section is triangle shape; Other structures keep the same as embodiment 33.

### Embodiment 35

The safe earphone as mentioned above,

The present embodiment sets the right air tube obliquely pulled from the speaker casing to the inlet of the right ear sound cavity, that is not passing along a metal headband.

Other structures keep the same as embodiment 33.

### Embodiment 36

The safe earphone as mentioned above,

Three air tubes in the present embodiment are pulled out of the E side of the switch casing and are connected to the inside of the left ear casing. Other structures keep the same as embodiment 33.

### Embodiment 37

The safe earphone as mentioned above,

The noise reduction safe over ear headphone in the present embodiment used as a mono circuit merges the left and right ear speakers into one speaker connected to one sound wave transmission tube by one sound collecting cavity, connects the sound wave transmission tube to the inlet of a tee of the left ear sound cavity, aforesaid tee has two outlets with one outlets connected to the inlet of the left ear sound cavity and the other connected to the left ear sound cavity by one sound wave transmission tube along the headband.

### Embodiment 38

The safe earphone as mentioned above,

The noise reduction safe over ear mono headphone in the present embodiment is provided with a flexible bow clip (199) mounted on a casing (200-1), a clamping piece 201 of round or other shapes mounted at the end point of the bow clip.

The one end of the microphone air tube (206) is connected to the small end of the sound collecting cavity of the converter, the big end of the sound collecting cavity is connected to the sound outlet face of the speaker of the converter, the other end of which is connected to the small end of a taper-shaped sound cavity (203-1), the big end of which is connected to the sound receiving face of the second microphone (204-1), the other end of the second microphone (204-1) is wired to the one end of the metal shielded wire (205) of which the other end is connected to the plug (206);

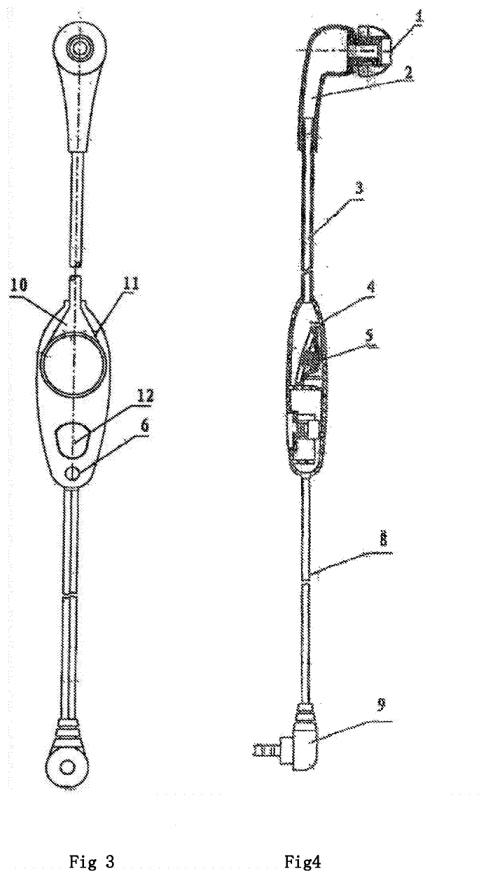

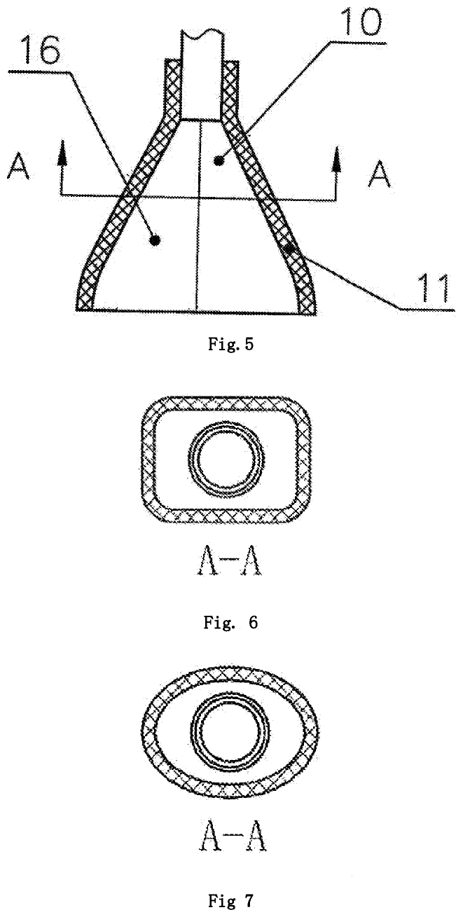

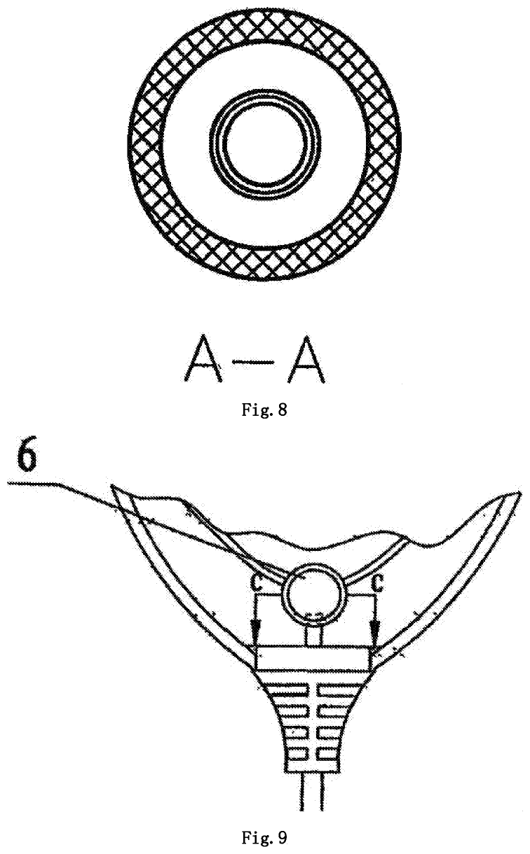

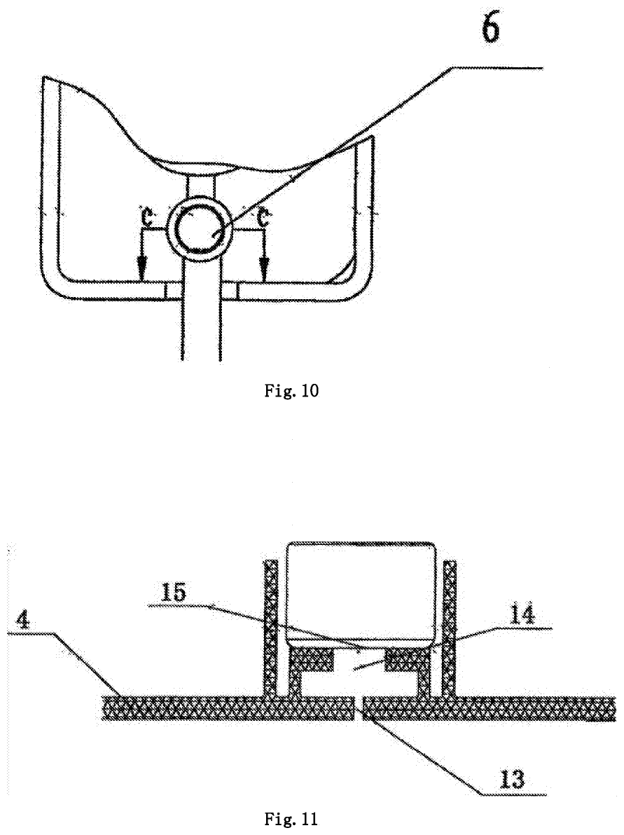

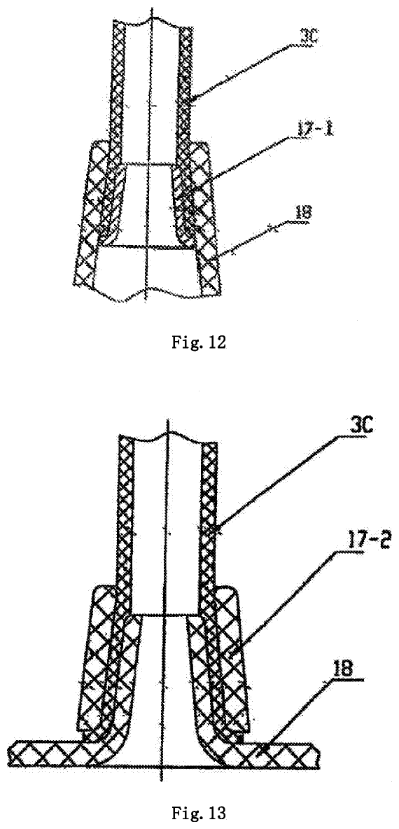

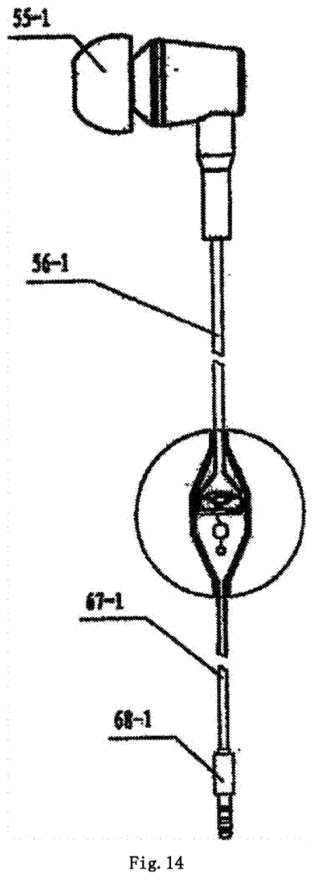

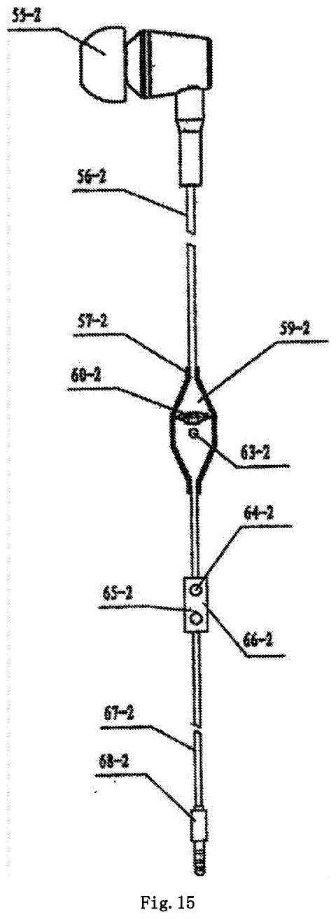

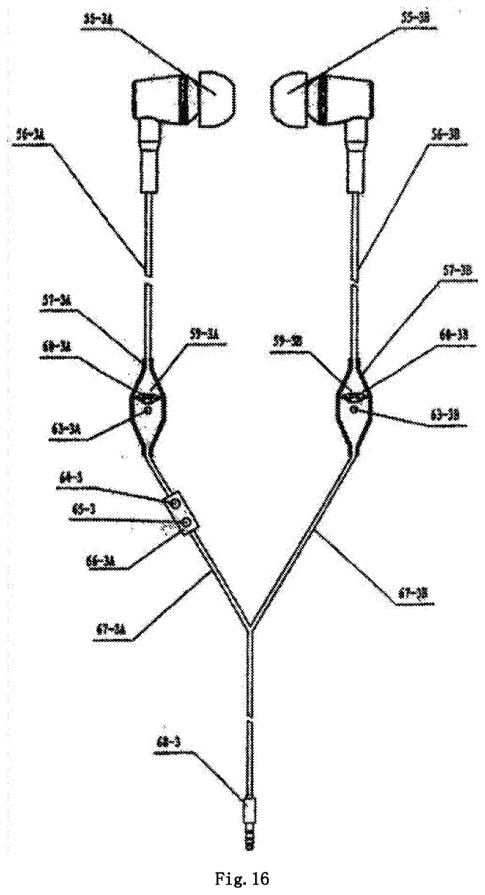

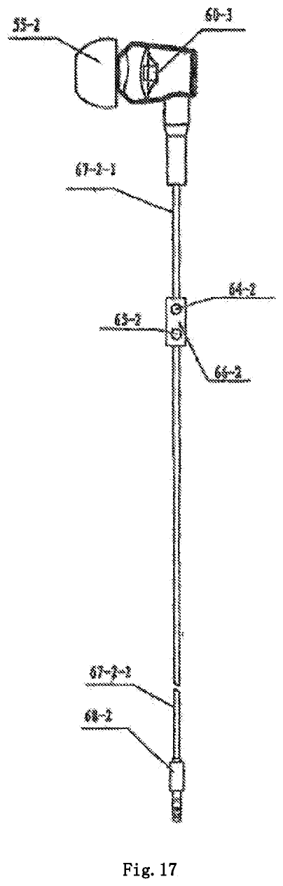

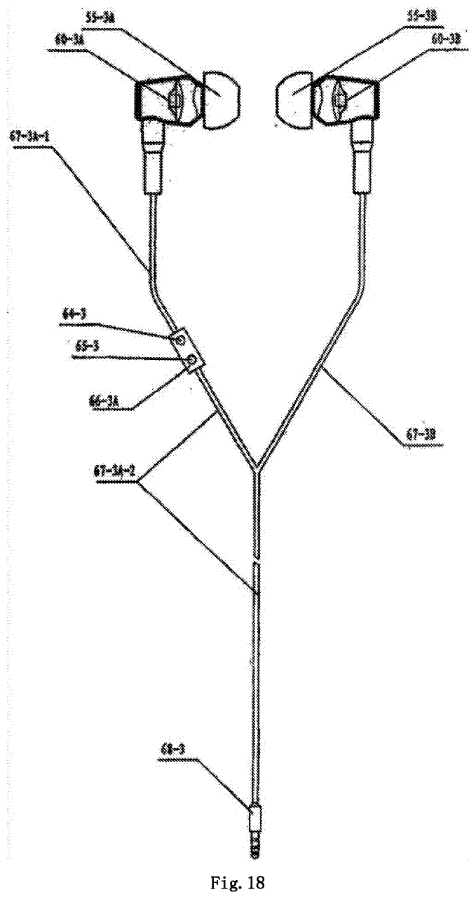

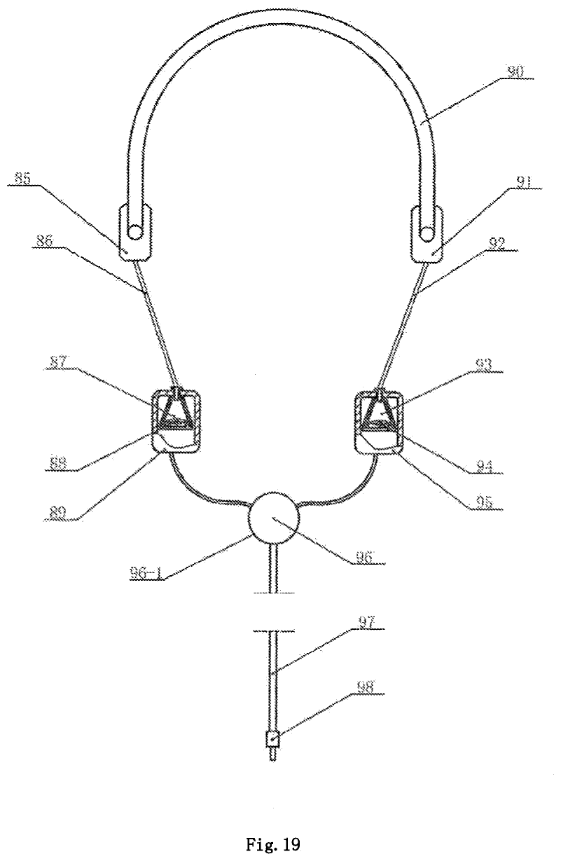

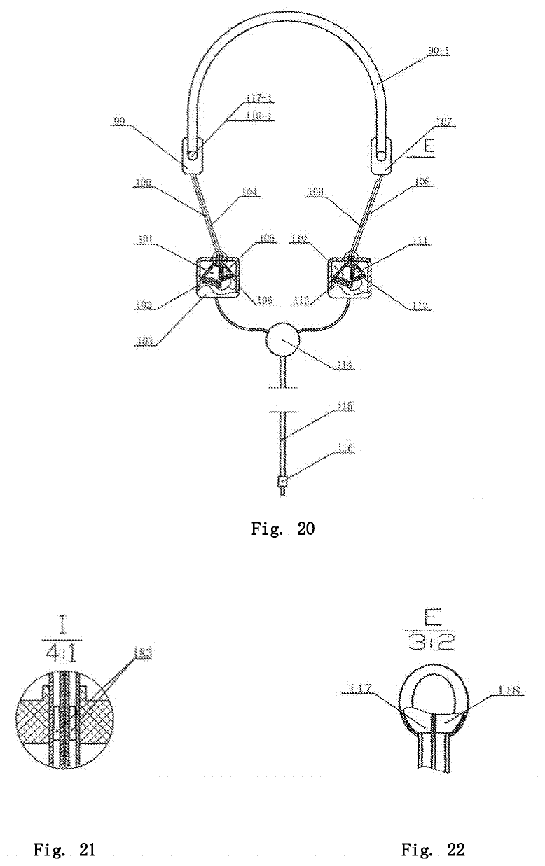

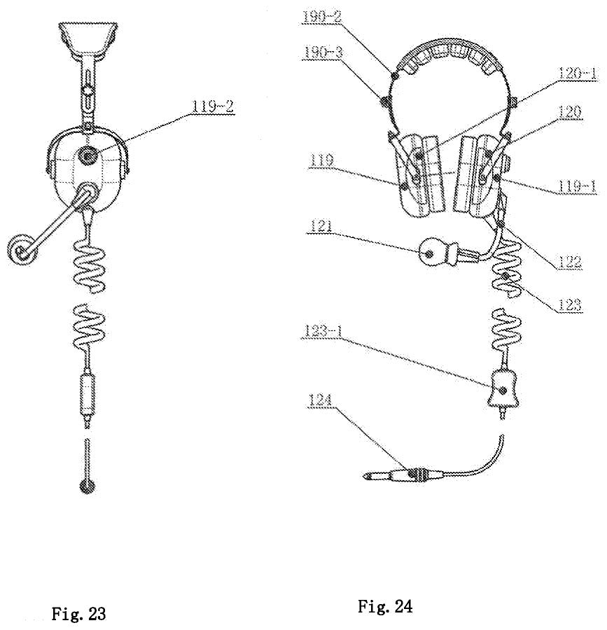

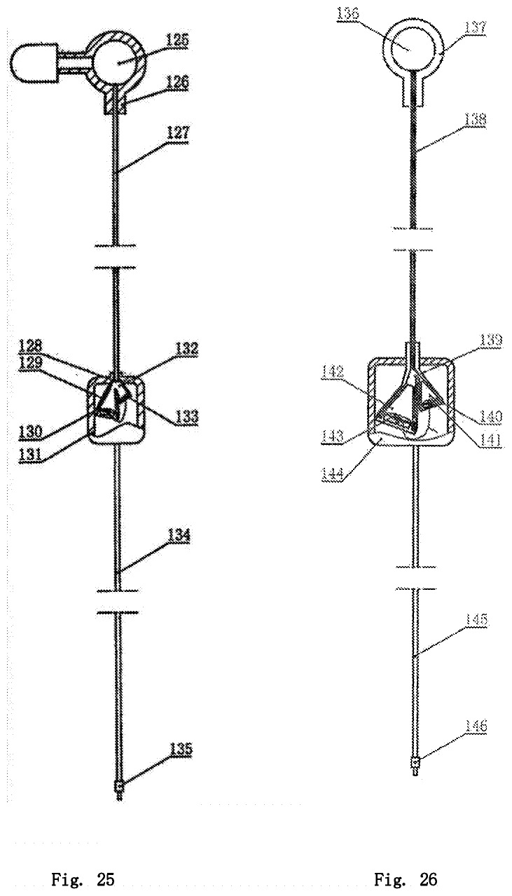

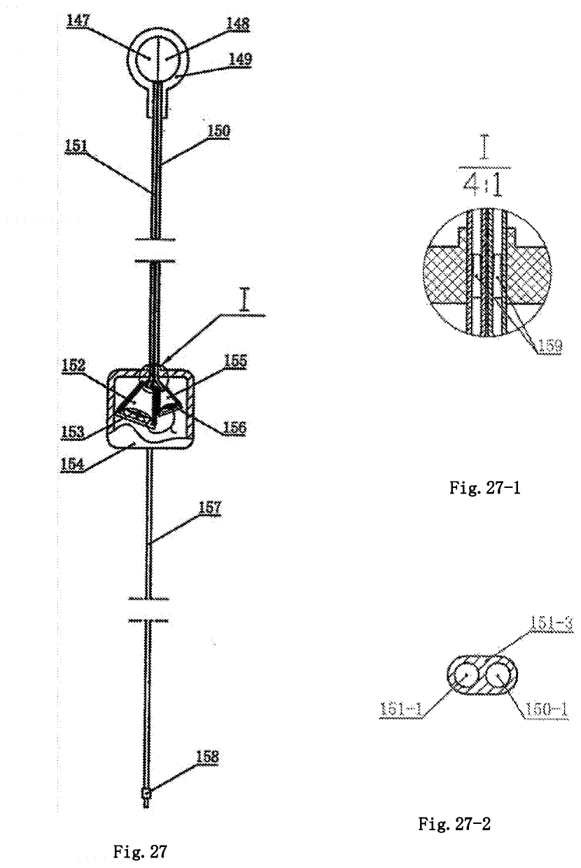

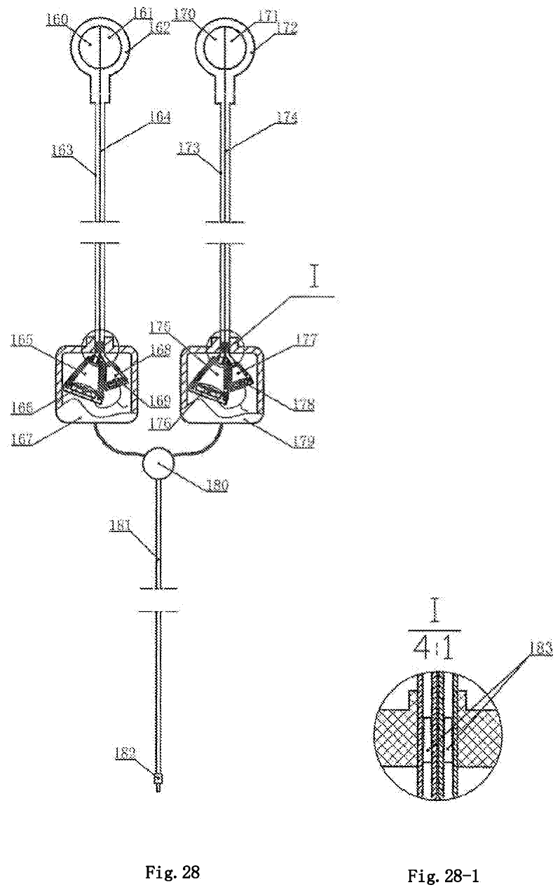

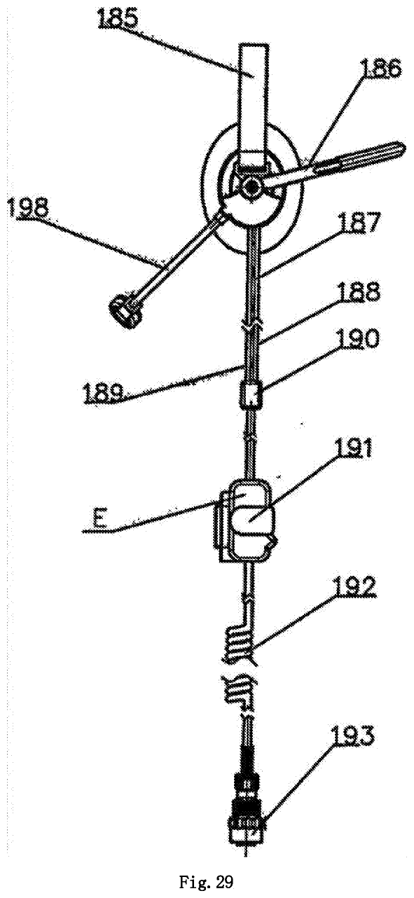

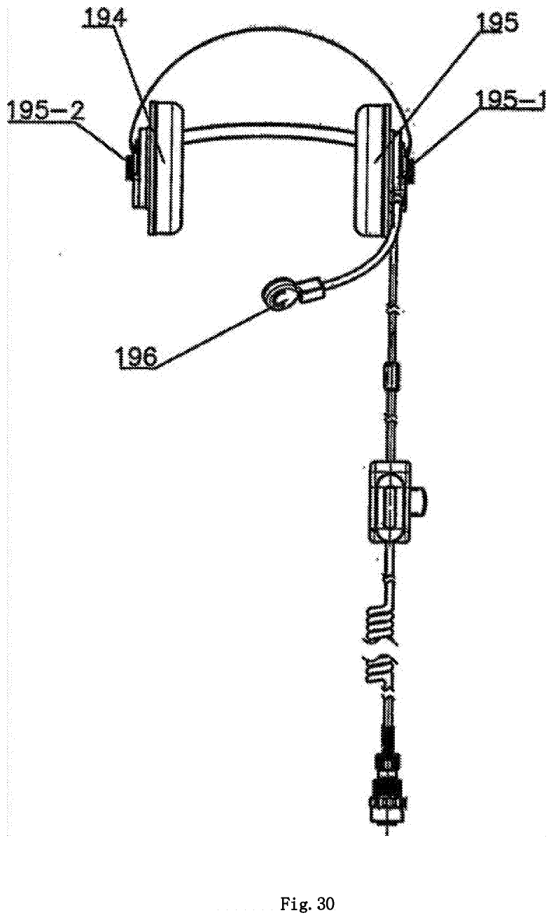

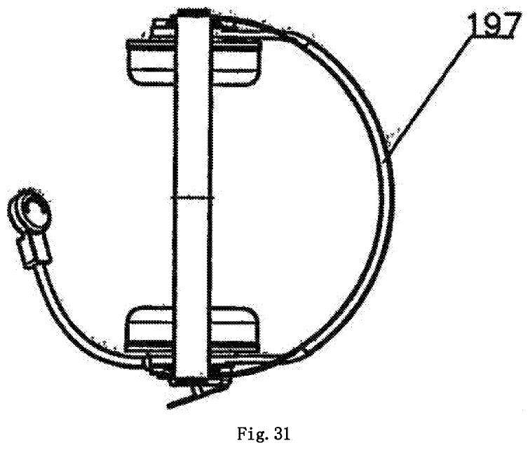

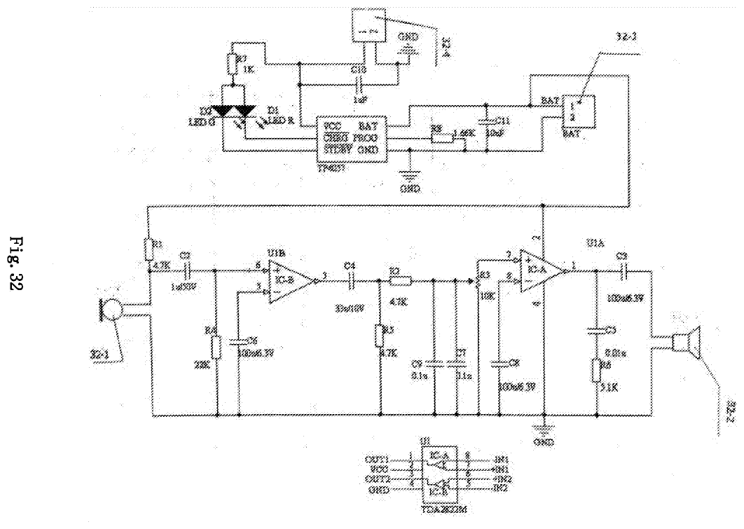

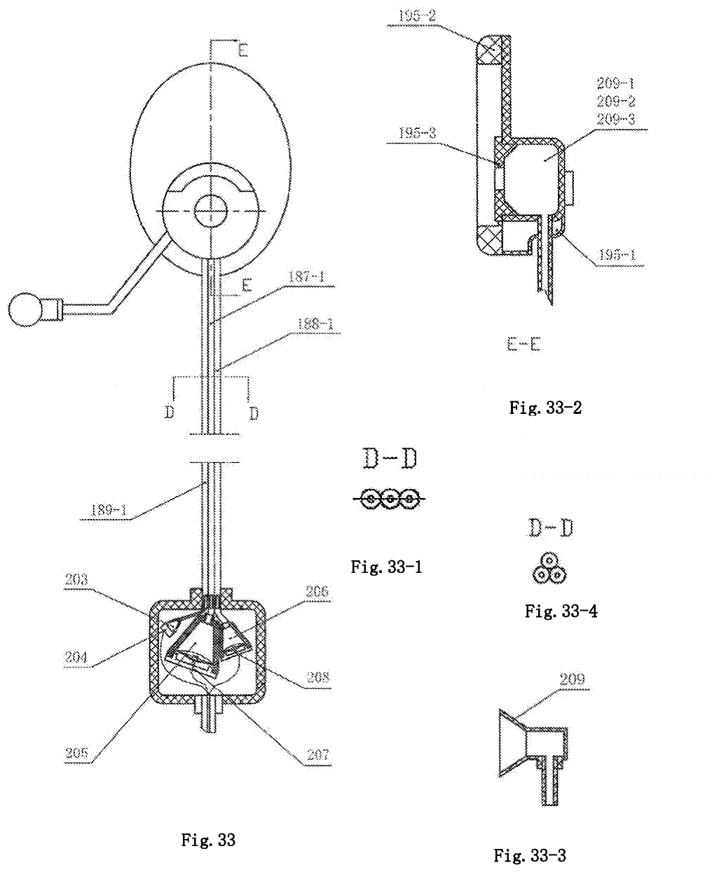

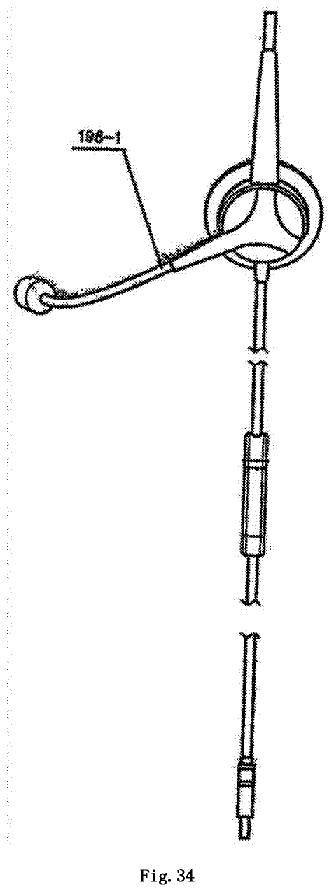

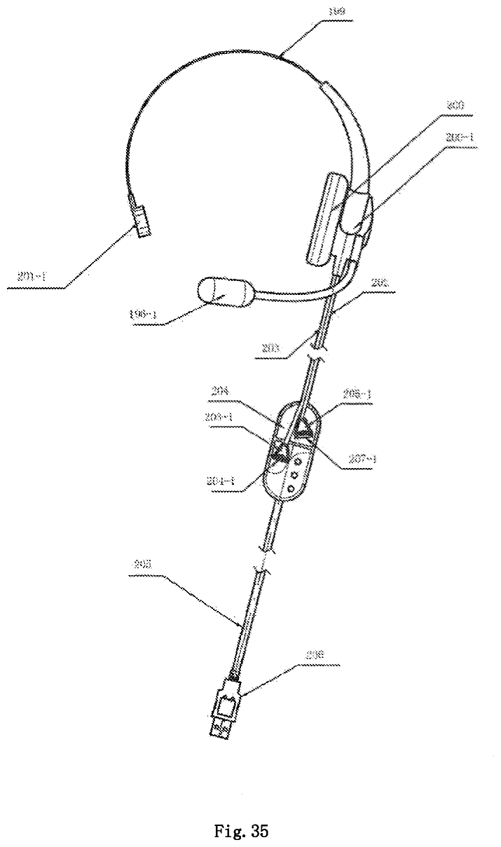

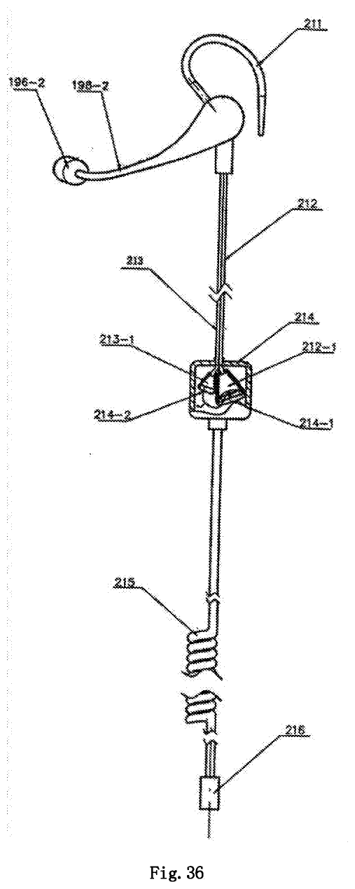

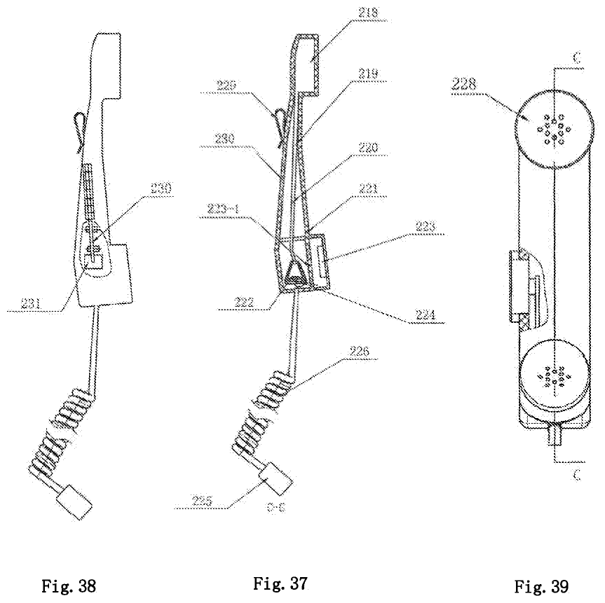

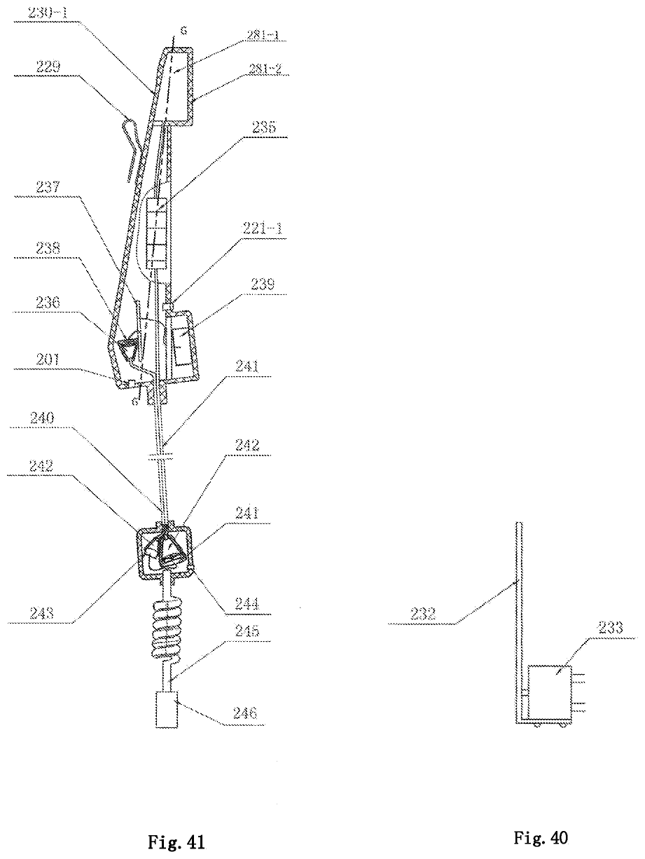

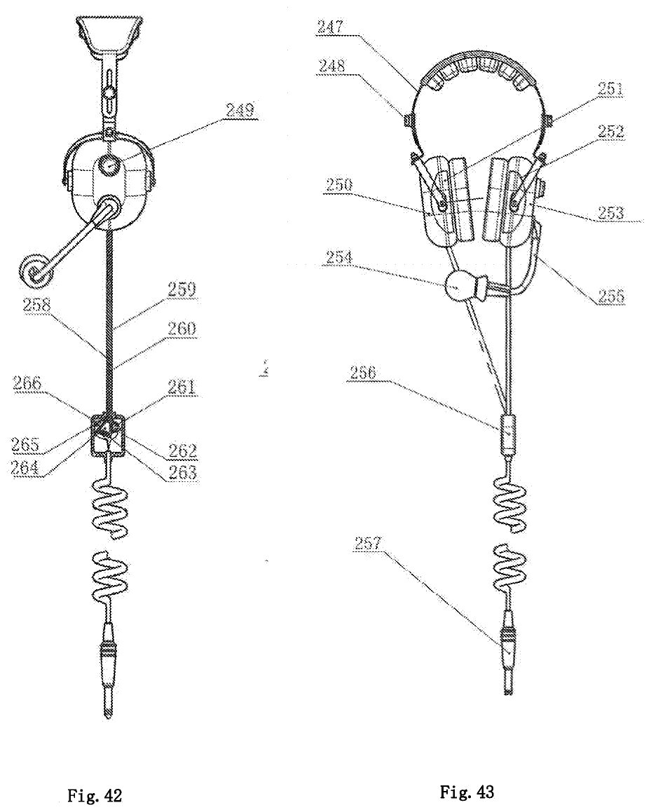

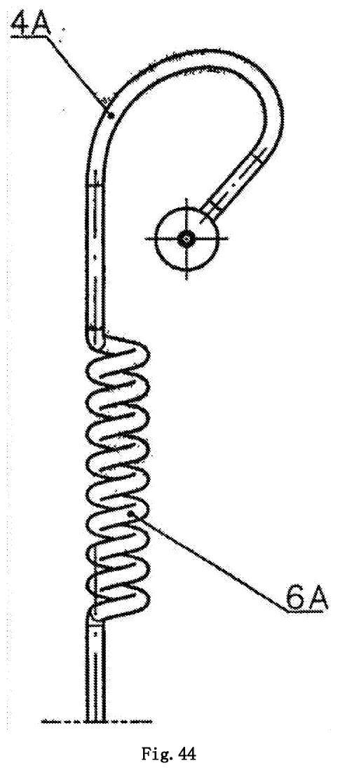

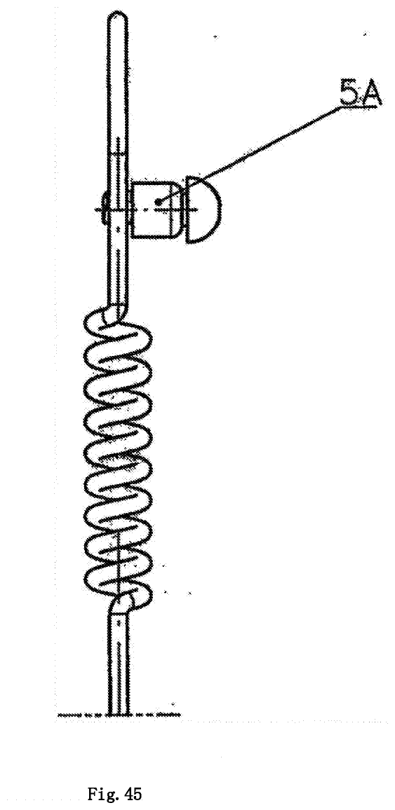

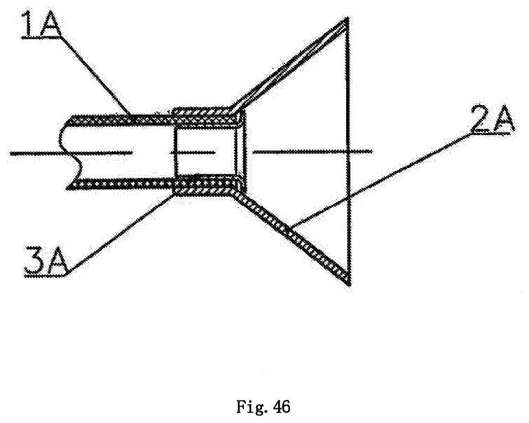

The one end of the left ear air tube (200-1) is connected to the inlet of the sound cavity producing the sound (structure as FIG. 33-2, sound cavity No.: 209-2) inside the casing (200-1), meanwhile the other end is connected to the small end of the sound collecting cavity (205-1), the big end of which is connected to the one end of the speaker (207-1) of which the other end is wired to the one end of the metal shielded wire (205), the other end of the metal shielded wire (205) is connected to the plug (206), the microphone, the left ear speaker and the sound collecting cavity uses a separator among them to isolate the sound.

The signal transmission of the microphone is converted from active transmission into passive transmission then restore to active transmission again, which allows setting the air tube very long, and the microphone keeps at a very close distance to the sound outlet to achieve noise reduction, and meanwhile super-highly protect the ear and brain from the harm of communication devices.

### Embodiment 39

The safe earphone as mentioned above,

A noise reduction safe mono ear hook earphone in the present embodiment is provided with a three-in-one bracket main body, the main body is provided with a ear hook (211), the front of which is a noise reduction transmission arm (198-2) having a conversion system (196-2) at its end, the main body is provided therein with a earplug with the sound cavity (structure as FIG. 33-2, sound cavity No. 209-3), the one end of the air tube (212) of the earplug is connected to the inlet of the sound cavity (209-3), meanwhile the other end of the air tube (212) is connected to the small end of the sound collecting cavity (212-1) having the speaker (214-1) mounted at the big end, both of the speaker (214-1) and the second microphone (214-2) are separately mounted in the speaker casing (214) to avoid the sound interference with each other; the circuit connection ways and structure of the conversion system and others are same as embodiment 38.

### Embodiment 40

The safe earphone as mentioned above,

A portable hand-held safe headset is provided with a hand arm (230) having a receiver sound cavity (218) with a top cover (228) at the top, the one end of the sound cavity (218) is connected to the one end of the air tube (220), meanwhile the other end of the air tube (220) is connected to the small end of the sound collecting cavity (222), the big end of the sound collecting cavity (222) is connected to the speaker (224), a connecting wire of the speaker (224) and the connecting wire of the microphone (223) are connected to the metal shielded wire (226) by the switch (231), the other end of the wire (226) is connected to the plug (225);

The switch (231) is set at the side of the middle of the portable hand-held safe headset, a button of the switch (231) operates the electric switch by the mechanical transmission of the link to disconnect or connect the speaker (224) and microphone (223).

### Embodiment 41

The safe earphone as mentioned above,

The present embodiment uses the top of the button of the switch pushing up a long arm (232) of a micro-switch (233) to disconnect or connect the micro-switch (233), other settings and structure keeps the same as embodiment 40, so that the active circuit is always kept at a distance from human brains, the microphone and the speaker are mounted in two cavities of which the sound is isolated from each other under the main body, the wire of the microphone is sealed with glue after passing through the separator, so that the arrangement can achieve a good anti-radiation effect

### Embodiment 42

The safe earphone as mentioned above,

The underpart of the main body (230-1) of the noise reduction portable hand held safe headset is provided with a noise reduction microphone signal conversion system: converting the transmission from the active audio signal into passive audio signal, and sets the first microphone (239) wired to a second audio amplifying circuit to drive the speaker (238), the sound outlet of the speaker (238) is connected to the big end of the sound collecting cavity (236), the small end of which is riveted to the one end of a microphone air tube (240), the other end of the microphone air tube (240) is connected to the small end of the taper-shaped sound cavity (243) of which the big end is connected to the sound receiving face of the second microphone, the connection between the sound outlet of the microphone and the sound receiving face of the second microphone is sealed, the other end of the second microphone (243) is wired to the one end of the metal shielded wire (245) of which the other end is connected to the plug (246);

The active part of the conversion system is provided with a battery to supply the power circuit and its elements, a charging circuit connected with battery and a charging socket and its LED, the speaker (238) and the first microphone (239) are separately mounted in the two cavities of which the sound is isolated from each other inside the main body (230-1), the wire of the first microphone is sealed with glue after passing through the separator.

The second microphone (243) and the speaker (241) are disposed in the casing (230-2) and are separated by a sound baffle, the sound receiving face of the speaker (241) is connected to the big end of the sound collecting cavity (242), the small end of which is connected to the air tube of the speaker (241). The other end of the air tube of the speaker is connected to the one end of a sound cavity (281-1). The speaker (241) is wired to the one end of a metal shielded wire (245), the other end of which is connected to the plug (246).

### Embodiment 43

The safe earphone as mentioned above,

A noise reduction aviation over-ear safe headphone in the present embodiment, it is provided with the structure including a leather headband, a stitched steel head bow (247), the head bow (247) and an adjustable bracket (251) fixed together by screws, the adjustable bracket (251) and a fixing bracket (252) are fixed together by self-locking nuts, the fixing bracket (252) is connected to a left ear casing (253) through lock pillars. the right ear casing (250) is connected and fixed in the symmetric and same way as the left ear casing (253).

The first noise reduction microphone is mounted in the noise reduction converter casing (254) connected to a universal hose (255) with a variable gear, the left ear and right ear sound cavity is disposed in the ear casing, the air tube (258) of the right sound cavity passes through the left ear casing and is connected to the sound cavity inside the right ear casing along a steel bow (247).

### Embodiment 44

The safe earphone as mentioned above,

The present embodiment shows that the speaker casing (256) is obliquely pulled to the the right ear casing and then to the sound cavity therein. Other structures keep the same as embodiment 43.

### Embodiment 45

The safe earphone as mentioned above,

Separately provides with three speakers with different frequency response, three sound wave transmission channels with different response, sound chambers connected to the channels and wires of sound wave transmission channels for one ear or two ear, the two earphones are separately provided with the moving iron speaker (166) (176) and the moving coil speaker (169) (178), each of them is separately disposed in big end of the sound collecting cavity (165) (175) and (178) (177), the sound collecting cavity (165) (175) and (178) (177) is separately configured to the one end of the air tube (163) (164) and (173) (174) of which the parallel end is separately connected to the sound cavity (160) (161) inside the earplug (162) and the sound cavity (170) (171) inside the earplug (172), adding one more pair of speakers, air tubes and sound chambers while setting the speaker with three different frequency response.

### Embodiment 46

The safe earphone as mentioned above,

Stereo model is the safe earphone with super high sound quality.

### Embodiment 47

The safe earphone as mentioned above,

Set to separately provides with several speakers with different frequency response for one ear or two ears is the noise reduction safe earphone with high sound quality.

### Embodiment 48

The safe earphone as mentioned above,

A safe over ear air tube headphone of the present embodiment, having two sound chambers connected to the air tube (86) (92) of which length is 300 mm, a audio cable uses the layer of an externally transparent or opaque metal shielded wire to make it grounded, one end of the audio cable is connected to the plug (98), and the other end is connected to a loudspeaker (88), the one end of the audio cable of a receiver (96) is also connected to the plug (98) and the other end is connected to the receiver (96) kept at a distance of 50 mm from the loudspeaker (88) (94), the microphone (96) is provided with a housing (96-1). The two ends of the air tube 1A and sound collecting cavities or a sound cavity 2A are all fixed with hollow 3A. The air tube is set to be a bend 4A which can be hooked to the ears. The end point of the bend 4A is provided with the earplug 5A having a sound cavity. And then the earplug 5A is putted into the ear for listening. Other settings are the same as embodiment 24.

It should be noted that the above embodiments are provided for describing the present invention in detail, but not intended to limit the scope of the present invention. Without departing from the scope the present invention, those skilled in the art can make various improvements and modifications, within the scope as defined by the appended claims.

### Embodiments of the Invention

The inventor has designed the sample which performs well after real performance test.

### INDUSTRIAL APPLICABILITY OF INVENTION

The power transmitted by the radio is much larger than that of the mobile phone, and people who work at radio station wear the headphone the whole day, so it is very necessary to prevent radiation. The noise reduction anti-radiation earphone of the present invention can set the air tube 1000 mm, or 3000-7000 mm in length or even much longer by converting the active signal into passive signal to achieve super highly radiation proof effect. As radiation is inversely proportional to the square of the distance in attenuation, which means the length of air tube is longer, the anti-radiation performance is increased proportional to the square of its length, and greatly improves the anti-radiation performance. So, the anti-radiation earphones are really needed in life.

Also, it can be used as an earphone for listening or speaking in the electromagnetic field scanning area of medical or other equipment, and the use of the earphone of the present invention in the electromagnetic field scanning area would not affect the scanning effect and quality, and thus achieves a good effect.

1-33. (canceled)

34. A safe earphone, comprises:
an ear cup (195,194), an ear cup casing (195-1, 195-2), a noise reduction transmission arm (198), a noise reduction converter (196), a speaker housing (190) and a plug (193), an air tube (187, 188) and
a noise reduction conversion system,
the ear cup (194, 195) is arranged on the ear cup casing (195-1, 195-2), the noise reduction converter (196) is connected to the ear cup casing (195-1) by the noise reduction transmission arm (198), the speaker housing (190) is connected to the ear cup casing (195-1, 195-2) by the air tube (187, 188), the speaker casing (190) is connected to the plug (193) by a metal shielded wire (192);
the noise reduction conversion system comprising: converting the transmission from the active audio signal of a first noise reduction microphone (32-1) into the passive audio signal, setting the first microphone (32-1) wired to a circuit of a second or third audio amplifier to push the speaker (32-2);
the noise reduction converter (196) is provided with the first microphone (32-1) wired to the circuit of the second or third audio amplifier, the middle of the noise reduction transmission arm (198) is provided with the speaker (32-2);
the sound outlet of the speaker (32-2) is connected to the big end of a sound collecting cavity, the small end of which is riveted to the one end of a microphone air tube (189-1), the other end of which is connected to the small end of a sound cavity of taper shape (203) of which the big end is connected to the sound receiving face of a second microphone (204); the connection by the air tube (189-1) between the sound outlet of the speaker (32-2) and the sound receiving face of the second microphone (204) is sealed; the other end of the second microphone (204) is wired to the one end of the metal shielded wire (192) of which the other end is connected to the plug (193), the other end of the plug (193) is connected to the socket of communication devices.

35. The earphone according to claim 34, is provided with a sound cavity producing sound (209-1), the sound cavity producing sound (209-1) is connected to the small end of the sound collecting cavity (205, 206) by the air tube (187-1, 188-1).

36. The earphone according to claim 35, is provided with a ear hook.

37. The earphone according to claim 35, the ear cup includes a left ear cup (195) and a right ear cup (194), the ear cup casing includes a left ear casing (195-1) and a right ear casing (195-2), the left ear cup (195) is arranged on the left ear casing (195-1), the right ear cup (194) is arranged on the right ear casing (195-2), the left ear casing (195-1) and the right casing (195-2) are connected by a headband (185).

38. The earphone according to claim 37, there is also a metal bow (186) connecting the left ear casing (195-1) and the right ear casing (195-2).

39. The earphone according to claim 38, the sound cavity producing sound comprises a left ear sound cavity and a right ear sound cavity, the left ear sound cavity has a tee having one inlet and two outlets; said speaker casing has one said speaker and one said sound collecting cavity, one said speaker is connected to one said sound collecting cavity, the sound collecting cavity is connected to the inlet of the tee by a left ear air tube, one of the outlet of the tee is connected to the left ear sound cavity, the other outlet of the tee is connected to the right ear sound cavity by a right ear air tube along the metal bow.

40. The safe earphone according to claim 37, is also provided with the left ear cup (195), the left ear casing (195-1), a sound chamber casing (195-3), the right ear cup (194), the right ear casing (195-2), the headband (185), a switch and its switch housing (191), the noise reduction transmission arm (198), and the noise reduction converter (196), a housing, the speaker casing (190), the plug (193); is provided with the noise reduction conversion system: converting the transmission of the first microphone (32-1) from the active audio signal into the passive audio signal, setting the first microphone (32-1) wired to the circuit of the second and third audio amplifier to push the speaker (32-2), the circuit is decided by the length and diameter of the selected microphone air tube and the first, second microphone or choose other chips, the big end of the sound collecting cavity is connected to the sound outlet of the speaker (32-2) and the small end is riveted to the one end of the microphone air tube (189-1) of which the other end is connected to the small end of the sound cavity of taper shape (203), the big end of the sound cavity of taper shape (203) is connected to the sound receiving face of the second microphone (204); the connection from the sound outlets of the speaker (23-2) through the air tube (189-1) to the sound receiving face of the second microphone (204) is sealed; the other end of the second microphone (204) is wired to the one end of the metal shielded wire (192) of which and the other end is connected to the one end of the plug (193), the other end of which is connected to the socket of communication devices;

41. The earphone according to claim 40, is provided with a left ear sound cavity and a right ear sound cavity, the left ear sound cavity is connected to the small end of the left sound collecting cavity (205) by the left ear air tube (187-1), the right ear sound cavity is connected to the small end of the right sound collecting cavity (206) by the right ear air tube (188-1); the right ear air tube (188-1) is connected to the small end of the right ear sound collecting cavity (206) along the outer edge of the metal bow (186) after passing through the left ear casing (195-1).

42. The earphone according to claim 40, the bevel/arc/curve edge of the two pairs at the periphery of the sound cavity of taper shape is of inversed taper shaper, the angle between bevel/arc/curve edges of each pair is between 9° and 130°; the periphery of the sound cavity of taper shape is of inversed taper shape with the peripheral formed by bevel lines; or the periphery of the sound cavity of taper shape is of the inversed taper shape with the peripheral formed by arc lines; or the periphery of the sound cavity of taper shape is of the inversed taper shape with the peripheral formed by curve lines; or the periphery of the sound cavity of taper shape is of the inversed taper shape with the peripheral formed by arc lines, curve lines and bevel lines together.

43. The earphone according to claim 40, both of the micro speaker and the microphone are connected to a switch and are connected to the metal shielded wire after then; the left and right ear speaker and the left and right ear sound collecting cavity and the second microphone are all disposed inside the switch casing.

44. A portable hand-held safe headset, comprises a hand arm (230), a sound cavity (218), an air tube (220), a sound collecting cavity (222), a speaker (224), a microphone (223), a switch (231), a metal shielded wire (226) and a plug (225), the hand arm (230) has a receiver sound cavity (218) at its top, the sound cavity (218) has a top cover (228), the one end of the sound cavity (218) is connected to the one end of the air tube (220) of which the other end is connected to the small end of the sound collecting cavity (222), the big end of which is connected to the speaker (224), the wire of the speaker (224) and the wire of the microphone (223) are connected to the metal shielded wire (226) by the switch (231), the other end of the metal shielded wire (226) is connected to the plug (225).

45. The earphone according to claim 44, the switch (231) is disposed at the side of the middle of said earphone, a button of the switch (231) disconnects or connects the speaker (224) and the microphone (223) by operating the mechanical transmission of the linkage.

46. The earphone according to claim 44, the button of the switch (232) pushes up a long arm (232) of a micro-switch (233) to connect or disconnect the micro-switch (233).

47. A noise reduction portable hand-held safe headset, comprises a main body (230-1), a speaker (238), a sound collecting cavity (236), a sound cavity of taper shape (242), a second microphone (243), a metal shielded wire (245) and a plug (246);
the underpart of the main body (230-1) is set with a noise reduction microphone signal conversion system: converting the transmission from the active audio signal into passive audio signal, and setting a first microphone (239) wired to a second audio amplifying circuit to drive the speaker (238);
the sound outlet of the speaker (238) is connected to the big end of the sound collecting cavity (236), the small end of which is riveted to the one end of a microphone air tube (240), the other end of which is connected to the small end of the sound cavity of taper shape (242) of which the big end is connected to the sound receiving face of the second microphone (243), the connection by the air tube (238) between the sound outlet of the speaker (238) and the sound receiving face of the second microphone (243) is sealed, the other end of the second microphone (243) is wired to the one end of the metal shielded wire (245) of which the other end is connected to the plug (246).
